(19) United States
(12) Patent Application Publication
(10) Pub. No.: US 2025/0077320 A1
(43) Pub. Date: Mar. 6, 2025

(54) Mapping-Aware and Memory Topology-Aware Message Passing Interface Collectives

(71) Applicant: Advanced Micro Devices, Inc., Santa Clara, CA (US)

(72) Inventors: Nithya Viswanathan Shyla, Thiruvananthapuram (IN); Manu Shantharam, San Diego, CA (US)

(73) Assignee: Advanced Micro Devices, Inc., Santa Clara, CA (US)

(21) Appl. No.: 18/458,571

(22) Filed: Aug. 30, 2023

(51) Int. Cl. G06F 9/54

(52) U.S. Cl. CPC G06F 9/546; G06F 2209/547

(57) ABSTRACT

A message passing interface processing system is described. In accordance with message passing logic, a node selects an affinity domain for communication of data associated with a message passing interface and selects a first rank of a first process of the message passing interface assigned to a first partition of the affinity domain as a first partition leader rank and an affinity domain leader rank. The node selects a second rank of a second process of the message passing interface assigned to a second partition of the affinity domain as second partition leader rank, receives the data at the first partition leader rank, and communicates the data from the first partition leader rank to the second partition leader rank.

### BACKGROUND

The message passing interface (MPI) is a communication protocol used in applications associated with high-performance computing (HPC), parallel computing, and cluster computing environments. MPI enables an application to create a logical group of processes (e.g., a communicator) that communicates collectively. MPI processes are indexed by rank. Thus, each process in the group is identified by its rank. MPI collectives (e.g., MPI collective functions) represent a set of communication patterns in MPI-based applications, where the ranks participate in computation operations (e.g., reduction) and data movement operations (e.g., broadcast, gather).

### BRIEF DESCRIPTION OF THE DRAWINGS

FIG. 1 is a block diagram of a non-limiting example implementation of an MPI processing system with logic for performing mapping-aware and memory topology-aware MPI collectives.

FIG. 2 is a block diagram of a non-limiting example implementation of an MPI processing system.

FIG. 3 is a flow diagram depicting an algorithm as a step-by-step procedure in an example of implementing an MPI processing system.

FIG. 4 is a flow diagram depicting an algorithm as a step-by-step procedure in an example of implementing an MPI processing system.

FIG. 5 is a flow diagram depicting an algorithm as a step-by-step procedure in an example of implementing an MPI processing system.

FIG. 6 is a block diagram of a non-limiting example implementation of message size relative to an example of implementing an MPI processing system.

FIG. 7 is a block diagram of a non-limiting example implementation of mapping and topology awareness in an example of implementing an MPI processing system.

FIG. 8 is a block diagram of a non-limiting example implementation of mapping and topology awareness in an example of implementing an MPI processing system.

FIG. 9 is a block diagram of a non-limiting example implementation of mapping and topology awareness in an example of implementing an MPI processing system.

FIG. 10 is a block diagram of a non-limiting example implementation of mapping and topology awareness in an example of implementing an MPI processing system.

FIG. 11 is a block diagram of a non-limiting example implementation of topology selection in an example of implementing an MPI processing system.

FIG. 12 is a block diagram of a non-limiting example implementation of topology selection in an example of implementing an MPI processing system.

FIG. 13 is a flow diagram depicting an algorithm as a step-by-step procedure in another example of implementing an MPI processing system.

FIG. 14 is a flow diagram depicting an algorithm as a step-by-step procedure in another example of implementing an MPI processing system.

### DETAILED DESCRIPTION

### Overview

Conventional message passing interface (MPI) libraries support process affinity to underlying hardware resources, enabling process-to-resource mappings where resources can be memory resources (e.g., cache and non-uniform memory access (NUMA) domains), processor cores, sockets, etc. As conventional MPI communication mechanisms (e.g., point-to-point, collectives) are agnostic to process-to-resource mappings, conventional approaches cannot exploit the benefits of data sharing through shared resources (e.g., data locality, performing computation at a node or location in the node where data for the computation resides). This is especially true of collectives where data is shared within a group of processes such as one-to-all transfer (e.g., MPI_beast, MPI_scatter) where one rank (e.g., root rank) sends data to all the other ranks in the communicator, all-to-one transfer (e.g., MPI_gather, MPI_reduce) where one rank receives data from all the other ranks in the communicator, or all-to-all transfers (e.g., MPI_allreduce, MPI_allgather) where all the ranks in the communicator send and receive data from one another.

Collective functions typically arrange the ranks in a tree topology, which can be flat tree (linear), binomial tree, binary tree, k-nomial tree, or chain tree, to name a few. Typically, the ranks communicate using the tree topology from parent to child or child to parent.

The conventional collective functions perform the data transfer based only on the rank of the process (e.g., in order of rank), irrespective of the pattern used to map the rank to hardware resources of the machine. In many processor architectures, the latency of this conventional approach varies across core pairs. In one or more processor architectures, the memory shared by the cores is organized in a hierarchy. For example, multiple processor cores share a memory component (e.g., L1, L2, L3 cache), several memory components are grouped to one NUMA, several NUMAs form a socket, and multiple sockets form a node.

The conventional process to hardware resource mappings are defined by a user or an application and MPI does not typically control such mappings. Since the conventional collective functions are not aware of the process-to-resource mappings, and the latency of data transfer between any two ranks depends on the latency of the data transfer across the cores to which the ranks are bound, which in turn depends on the smallest level at which the two cores share a resource group, the conventional collective functions cannot perform optimally across hardware architectures and mapping patterns.

Conventional MPI approaches are agnostic to process affinity (e.g., process-to-resource mapping), as well as hardware topology and system properties such as hierarchical memory layout and latencies within and across processor components, resulting in suboptimal utilization of hardware resources. Because they lack this topology and process affinity awareness, conventional MPI approaches are not capable of selecting hierarchical levels for a given architecture or selecting an appropriate variant within an MPI collective for each level of the hierarchy based on message sizes. Conventional MPI approaches do not minimize data movement across affinity domain partitions (e.g., across two different NUMA domains, across different sockets, etc.).

Being aware of process affinity and the hardware topology opens up new optimization opportunities for the MPI collective functions. The described techniques provide process affinity and hardware topology aware MPI collective communication to utilize efficiently the underlying processor architecture and properties, thereby improving the latencies of MPI collective functions on any given processor.

The described techniques provide message passing logic (e.g., of a message passing interface) that enables MPI collective functions that are mapping-aware and memory topology-aware. The added logic considers the process-to-resource mapping (e.g., process affinity) and provide optimal performance irrespective of the mapping pattern. The message passing logic considers the process affinity during data transfer within an MPI collective, and keeps the inter-node data transfers (e.g., data transfers between nodes) to a minimum. Since the latency of data transfer across cores belonging to the same node is lower than that across cores belonging to different nodes, performance improvement is achieved by keeping most of the data transfer among those ranks which are mapped to the cores belonging to the same node.

The message passing logic includes hierarchically grouping MPI processes by mapping ranks to virtual ranks based on their process affinity to the underlying hardware. The message passing logic minimizes communication across affinity domains partitions (e.g., socket affinity domain, NUMA affinity domain, memory affinity domain, core affinity domain, etc.). The message passing logic provides logic-based selection of affinity domains for the given processor architecture and process-to-resource mapping.

In one or more examples, an affinity domain includes two or more partitions. For example, a socket affinity domain includes socket 0 (e.g., a first socket affinity domain partition) and socket 1 (e.g., a second socket affinity domain partition). The message passing logic selects a leader rank for each affinity domain partition (e.g., a first or primary leader rank for a first NUMA partition, a second leader rank for a second NUMA partition, and so on). The message passing logic maps the leader ranks to virtual leader ranks, group the leader ranks and map the group to a group of virtual leader ranks per affinity domain. Based on the added logic, the message passing logic provides a choice of resource group levels based on message size and a choice of tree topology for communication at every affinity domain level based on the message size.

The message passing logic provides flexibility in choosing a tree topology for communication among the leader ranks of an affinity domain under a next highest affinity domain partition and among the ranks within a lowest affinity partition. For example, at the socket affinity domain, the socket leader ranks communicate using a first tree topology. At the NUMA affinity domain in each of the socket partition, the NUMA partition leader ranks communicate using a second tree topology that is the same as or different from the first tree topology. At the memory affinity domain in each of the NUMA partitions, the memory partition leader ranks communicate using a third tree topology that is the same as or different from the first and/or second tree topology. At the leaf ranks (e.g., non-leader ranks) within the memory level partition (e.g., when the memory level is the lowest affinity domain), the leaf ranks communicate using a fourth tree topology that is the same as or different from the first, second, and/or third tree topology.

In some aspects, the techniques described herein relate to a node including: one or more processors, and one or more computer-readable storage media storing instructions that are executable by the one or more processors to cause the node to: select an affinity domain for communication of data associated with a message passing interface, select a first rank of a first process of the message passing interface assigned to a first partition of the affinity domain as a first partition leader rank and an affinity domain leader rank, select a second rank of a second process of the message passing interface assigned to a second partition of the affinity domain as second partition leader rank, receive the data at the first partition leader rank, and communicate the data from the first partition leader rank to the second partition leader rank.

In some aspects, the techniques described herein relate to a node, wherein reception of the data at the first partition leader rank is based on: the selection of the first partition leader rank as the affinity domain leader rank, and the affinity domain leader rank being mapped, by the node, to a virtual affinity domain leader rank.

In some aspects, the techniques described herein relate to a node, wherein the communication of the data from the first partition leader rank to the second partition leader rank is based on at least one of: the selection of the first partition leader rank as the affinity domain leader rank, and the second partition leader rank being subordinate to the affinity domain leader rank within the affinity domain.

In some aspects, the techniques described herein relate to a node, wherein the communication of the data from the first partition leader rank to the second partition leader rank is based on: the first partition leader rank being mapped, by the node, to a virtual first partition leader rank, and the second partition leader rank being mapped, by the node, to a virtual second partition leader rank subordinate to the virtual first partition leader rank.

In some aspects, the techniques described herein relate to a node, wherein further instructions are executable by the one or more processors to cause the node to communicate the data from the first partition leader rank to each of one or more first partition subordinate ranks, the first partition including the first partition leader rank and the one or more first partition subordinate ranks.

In some aspects, the techniques described herein relate to a node, wherein the communication of the data from the first partition leader rank to each of the one or more first partition subordinate ranks is based on a mapping of: the first partition leader rank to the virtual first partition leader rank, and each of the one or more first partition subordinate ranks to respective virtual first partition subordinate ranks.

In some aspects, the techniques described herein relate to a node, wherein further instructions are executable by the one or more processors to cause the node to: map each of one or more second partition subordinate ranks to respective virtual second partition subordinate ranks, and communicate the data from the virtual second partition leader rank to the respective virtual second partition subordinate ranks.

In some aspects, the techniques described herein relate to a node, wherein the selection of the affinity domain is based on further instructions executable by the one or more processors to cause the node to select one or more affinity domains for the communication of the data from a list of affinity domains that includes a node level, a socket level within the node level, a non-uniform memory access level within the socket level, a memory level within the non-uniform memory access level, and a processor core level within the memory level.

In some aspects, the techniques described herein relate to a node, wherein the selection of the affinity domain is based on at least one of a processor architecture, a mapping of processes of the message passing interface to hardware resources of the node, or a size of the data.

In some aspects, the techniques described herein relate to a node, wherein the selection of the affinity domain is based on further instructions executable by the one or more processors to cause the node to: select at least the processor core level when a message size is below a first threshold, select at least the processor core level and the memory level when the message size exceeds the first threshold, select at least a majority of affinity domains from the list of affinity domains when the message size exceeds a second threshold greater than the first threshold, select at least the node level and the socket level when the message size exceeds a third threshold greater than the second threshold, and select at least the node level when the message size exceeds a fourth threshold greater than the third threshold.

In some aspects, the techniques described herein relate to a method including: selecting an affinity domain for communication of data associated with a message passing interface, selecting a first rank of the message passing interface assigned to a first partition of the affinity domain as a first partition leader rank and an affinity domain leader rank, selecting a second rank of the message passing interface assigned to a second partition of the affinity domain as second partition leader rank, receiving the data at the first partition leader rank, and communicating the data from the first partition leader rank to the second partition leader rank.

In some aspects, the techniques described herein relate to a method, wherein receiving the data at the first partition leader rank is based on: the selecting the first partition leader rank as the affinity domain leader rank, wherein the affinity domain leader rank is a leader rank for an immediate next higher level affinity domain partition, and mapping the affinity domain leader rank to a virtual affinity domain leader rank.

In some aspects, the techniques described herein relate to a method, wherein the communicating the data from the first partition leader rank to the second partition leader rank is based on at least one of: the selecting the first partition leader rank as the affinity domain leader rank, and the second partition leader rank being subordinate to the affinity domain leader rank within the affinity domain.

In some aspects, the techniques described herein relate to a method, wherein the communicating the data from the first partition leader rank to the second partition leader rank is based on: mapping the first partition leader rank to a virtual first partition leader rank, and mapping the second partition leader rank to a virtual second partition leader rank subordinate to the virtual first partition leader rank.

In some aspects, the techniques described herein relate to a method, further including communicating the data from the first partition leader rank to each of one or more first partition subordinate ranks, the first partition including the first partition leader rank and the one or more first partition subordinate ranks.

In some aspects, the techniques described herein relate to a method, wherein the communication of the data from the first partition leader rank to each of the one or more first partition subordinate ranks is based on: mapping the first partition leader rank to a virtual first partition leader rank, and mapping each of the one or more first partition subordinate ranks to respective virtual first partition subordinate ranks.

In some aspects, the techniques described herein relate to a node including: one or more processors, and one or more computer-readable storage media storing instructions that are executable by the one or more processors to cause the node to: select a first affinity domain partition of an affinity domain and a second affinity domain partition of the affinity domain for communication of data associated with a message passing interface, select a first rank of the message passing interface assigned to the first affinity domain partition as a first affinity domain leader rank, select a second rank of the message passing interface assigned to the second affinity domain partition as second affinity domain leader rank, and communicate the data from the first affinity domain leader rank to the second affinity domain leader rank.

In some aspects, the techniques described herein relate to a node, wherein further instructions are executable by the one or more processors to cause the node to: assign a first tree topology to the first affinity domain partition, and assign, to the second affinity domain partition, a second tree topology.

In some aspects, the techniques described herein relate to a node, wherein the communication of the data from the first affinity domain leader rank to the second affinity domain leader rank is based on further instructions executable by the one or more processors to cause the node to map: the first affinity domain leader rank to a first virtual affinity leader rank, and the second affinity domain leader rank to a second virtual affinity leader rank.

In some aspects, the techniques described herein relate to a node, wherein the communication of the data from the first affinity domain leader rank to the second affinity domain leader rank is based on further instructions executable by the one or more processors to cause the node to: group the first affinity domain leader rank and the second affinity domain leader rank with a first group of leader ranks of the first affinity domain partition, map the first affinity domain leader rank as a virtual first affinity domain leader rank over the first group of leader ranks, and group the second affinity domain leader rank with a second group of leader ranks in the second affinity domain partition, and map the second affinity domain leader rank as a second virtual affinity group leader rank of the second group of leader ranks.

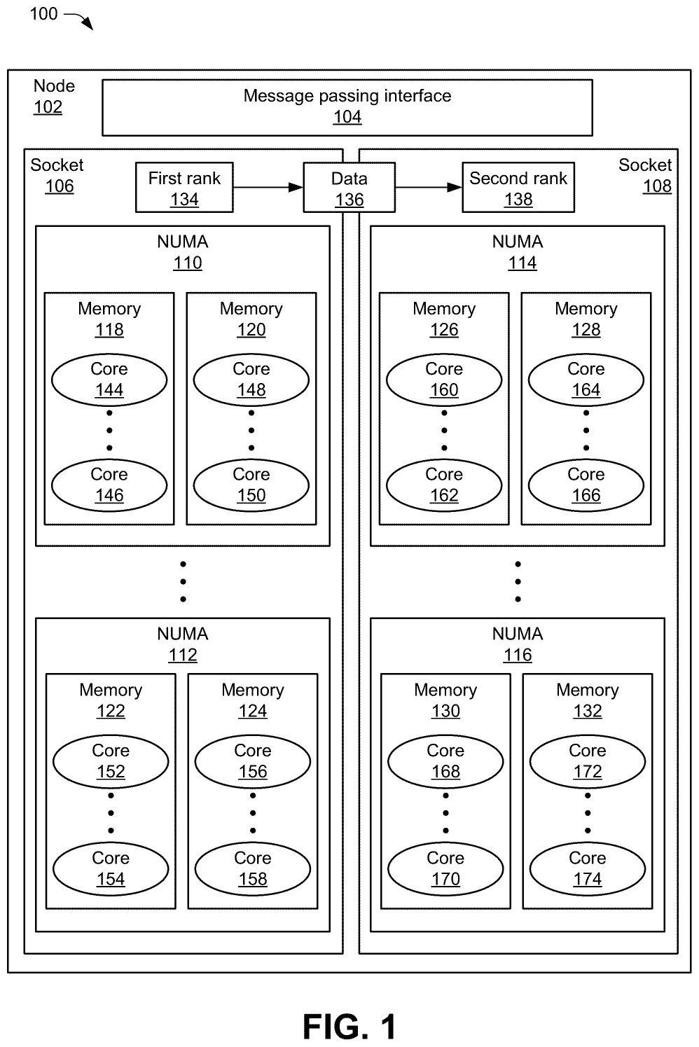

FIG. 1 is a block diagram of a non-limiting example implementation 100 of an MPI processing system having logic for performing mapping-aware and memory topology-aware MPI collectives.

In the illustrated example, implementation 100 includes one node partition the node 102. The node 102 includes a message passing interface 104 and two socket partitions: a socket 106 and a socket 108. The message passing interface 104 includes software and/or hardware (e.g., message passing logic) that enables MPI collective functions that are mapping-aware and memory topology-aware. The socket 106 includes a first rank 134 and multiple NUMA domain partitions (e.g., four NUMA domain partitions): NUMA 110 to the NUMA 112. In the illustrated example, the socket 108 includes a second rank 138 and multiple NUMA domain partitions (e.g., four NUMA domain partitions): NUMA 114 to NUMA 116. The NUMA 110 includes multiple memory partitions (e.g., two memory partitions): a memory 118 and a memory 120. The NUMA 112 includes two memory partitions a memory 122 and a memory 124. The NUMA 114 includes multiple memory partitions (e.g., two memory partitions): a memory 126 and a memory 128. The NUMA 116 includes multiple memory partitions (e.g., two memory partitions): a memory 130 and a memory 132. The memory 118 includes multiple processor core partitions (e.g., sixteen processor core partitions, based on 128 cores divided into eight NUMA partitions): a core 144 to a core 146. The memory 120 includes multiple processor core partitions (e.g., sixteen processor core partitions): a core 148 to a core 150. The memory 122 includes multiple processor core partitions (e.g., sixteen processor core partitions): a core 152 to a core 154. The memory 124 includes multiple processor core partitions (e.g., sixteen processor core partitions): a core 154 to a core 156. The memory 126 includes multiple processor core partitions (e.g., sixteen processor core partitions): a core 158 to a core 160. The memory 128 includes multiple processor core partitions (e.g., sixteen processor core partitions): a core 162 to a core 164. The memory 130 includes multiple processor core partitions (e.g., sixteen processor core partitions): a core 166 to a core 168. The memory 132 includes multiple processor core partitions (e.g., sixteen processor core partitions): a core 170 to a core 174.

Implementation 100 depicts affinity domain hierarchies/levels for a given processor architecture resource group. Implementation 100 is just one example hierarchy among multiple possible affinity domain hierarchies. The message passing logic may be implemented on affinity domain hierarchies with higher or lower number of affinity domain levels than those depicted in implementation 100, or a subset of the depicted affinity domain levels. For instance, a given machine implementing the message passing logic uses shared resource groups of one or more memory partitions (e.g., L1/L2/L3 cache partitions) and one or more NUMA partitions. Another machine implementing the message passing logic uses hardware threads at one or more cores, one or more memory partitions, and one or more NUMA partitions.

The lowest level in the affinity domain corresponds to processes sharing the same processor core (e.g., hardware threads in a given core of the core 144 to the core 172). The next level in the affinity domain hierarchy corresponds to processes sharing the same memory (e.g., the memory 118 to the memory 132). The next level in the affinity domain hierarchy corresponds to processes sharing the same NUMA (e.g., the NUMA 110 to the NUMA 116). The next level in the affinity domain hierarchy corresponds to processes sharing the same socket (e.g., the socket 106 and 108). The highest level in the affinity domain hierarchy corresponds to processes sharing the same node (e.g., the node 102). The latency of data transfer progressively increases from the lowest level (e.g., the core 144 to the core 174) to the highest level in the hierarchy (e.g., the node 102).

Let us call the resources shared at each hierarchy as a resource group. Table 1 lists the terminology associated with the message passing logic.

TABLE 1
Terminology and definitions

| | |
|---|---|
| Affinity | Shared resource group at a given level i = 1, 2, . . . , |
| Domain | N, where i = 1 corresponds to the lowest level and i = |
| (Aff_{Di}) | N corresponds to the highest level. For example, the |
| | affinity domain at the socket level includes the shared |
| | resource group for the socket 106 and the socket 108. |
| Affinity | Each distinct resource group of Aff_{Di}. For example, for |
| Domain | the socket level, if there are 2 sockets per node, there |
| Partition | are two PAff_{GDi}s per node at the socket level. The |
| (PAff_{GDi}) | socket 106 depicts a first affinity domain partition at |
| | the socket level. The socket 108 depicts a second |
| | affinity domain partition at the socket level. The |
| | NUMA 110 depicts a first affinity domain partition at |
| | the NUMA level. The NUMA 112 depicts a first |
| | affinity domain partition at the NUMA level, and so on. |
| Affinity Group | All the processes (e.g., ranks) that belong to the same |
| (Aff_{GDi}) | affinity domain partition (PAff_{Di}). The affinity group |
| | (Aff_{GD(N+1)}) includes all the processes in a given |
| | communicator. The affinity group at the socket level |
| | includes all the processes of the socket 106 and the |
| | socket 108. The affinity group at the NUMA level |
| | under the socket 106 partition includes all the processes |
| | of the NUMA 110 (first affinity group at NUMA level) |
| | to the NUMA 112 (second affinity group at NUMA |
| | level). The affinity group at the NUMA level under the |
| | socket 108 partition includes all the processes of the |
| | NUMA 114 (third affinity group at NUMA level) to |
| | NUMA 116 (fourth affinity group at NUMA level). |
| Collective | Set of all Affinity Groups (Aff_{GDi}s) for a given Affinity |
| Affinity Group | Domain Partition (PAff_{GD(i+1)}). For example, the |
| (CAff_{GDi}) | collective affinity group for the socket 106 = {set of |
| | processes belonging to NUMA 110, . . . , set of processes |
| | belonging to NUMA 112}. The collective affinity |
| | group for the NUMA 110 = { set of processes belonging |
| | to Memory 118, set of processes belonging to Memory |
| | 120}. |
| Collective | A set of leaders, one leader from each element of |
| Leaders | CAff_{GDi}. For example, the leader rank of the socket 106 |
| CAff_{GD} | among multiple leader ranks of the NUMA levels of the |
| (LCAff_{GDi}) | socket 106, the leader rank of the socket 108 among |
| | multiple leader ranks of the NUMA levels of the socket |
| | 108, etc. |

Regardless of the process-to-resource mapping, the message passing logic groups the ranks belonging to a resource group at each hierarchy level (e.g., affinity group). The message passing logic achieves improved performance on MPI collectives for any processor architecture. This is achieved by dividing the ranks into different partitions (Aff_{GDi} of Table 1) that share the same resource group, and limiting the cross-partition data transfers to a minimum for the communication.

In one or more implementations, the message passing interface 104 selects one or more affinity domains from a list of affinity domains. The message passing interface 104 selects the one or more affinity domains for the communication of data. In the illustrated example, the list of affinity domains includes a node level (e.g., the node 102), a socket level within the node level (e.g., the socket 106 and the socket 108), a NUMA level within the socket level (e.g., the NUMAs 110 to 114), a memory level within the NUMA level (e.g., the memory 118 to the memory 132), and a processor core level within the memory level (e.g., the core 144 to the core 174).

In one or more implementations, the message passing interface 104 selects the socket 106 as a first affinity domain partition of the socket level and selects the NUMA 110 as a first affinity domain partition of the NUMA level. In one or more examples, the message passing interface 104 selects the socket 108 as a second affinity domain partition of the socket level and selects the NUMA 114 as a second affinity domain partition of the NUMA level.

In one or more implementations, the message passing interface 104 selects the first rank 134 (e.g., a root rank) of a first process assigned to the socket 106 as a first affinity domain leader rank (e.g., the leader rank of the socket 106). In one or more examples, the message passing interface 104 selects the second rank 138 (e.g., a root rank) of a first process assigned to the socket 108 as a second affinity domain leader rank (e.g., a second leader rank of the same affinity domain, the leader rank of the socket 108). In one or more examples, the message passing interface 104 communicates the data 136 from the affinity domain leader rank of the socket 106 (e.g., the first rank 134) to the affinity domain leader rank of the socket 108 (e.g., the second rank 138). In one or more examples, the first rank 134 is a leader rank of the socket 106 and the second rank 138 is a leader rank of the socket 108. Additionally or alternatively, the first rank 134 is also the leader rank of the NUMA 110, the leader rank of the memory 118, and the leader rank of the core 144. Additionally or alternatively, the second rank 138 is also the leader rank of the NUMA 114, the leader rank of the memory 126, and the leader rank of the core 160. Accordingly, in one or more variations, the data 136 received by the second rank 138 results in the data 136 being received by the leader rank of the NUMA 114, the leader rank of the memory 126, and/or the leader rank of the core 160.

In one or more implementations, the message passing interface 104 assigns a first tree topology to the socket affinity domain (e.g., based on the leader rank of the socket 106 and the leader rank of the socket 108). In one or more implementations, the message passing interface 104 assigns a second tree topology different from the first tree topology to the NUMA affinity domain (e.g., based on the respective leader ranks of the NUMAs 110 to 112 in the socket 106 and those of the NUMA 114 to the NUMA 116 in the socket 108).

In one or more variations, the communication of the data from the first affinity domain leader rank to the second affinity domain leader rank (e.g., the first rank 134 to the second rank 138) is based on the message passing interface 104 mapping the first affinity domain leader rank to a first virtual affinity domain leader rank, and mapping the second affinity domain leader rank to a second virtual affinity leader rank.

In one or more variations, the communication of the data from the first affinity domain leader rank (e.g., the first rank 134) to the second affinity domain leader rank (e.g., the second rank 138) is based on the message passing interface 104 grouping the first rank 134 as the affinity domain leader rank of the socket 106 and the second rank 138 as the affinity domain leader rank of the socket 108 with a group of leader ranks of the socket affinity domain. For example, the message passing interface 104 groups the first rank 134 into a first socket partition group of leader ranks and groups the second rank 138 into a second socket partition group of leader ranks. In one or more examples, the message passing interface 104 maps the first rank 134 (e.g., affinity domain leader rank of the socket 106) as a virtual first socket affinity domain leader rank over the first socket partition group of leader ranks.

The message passing logic provides a framework for obtaining optimal performance with MPI collectives on various processor configurations. Performance of MPI collectives on various architectures is improved by making the collective functions aware of the underlying topology for latency reduction. The message passing logic provides a framework for obtaining optimal performance with MPI collectives on various processor architectures.

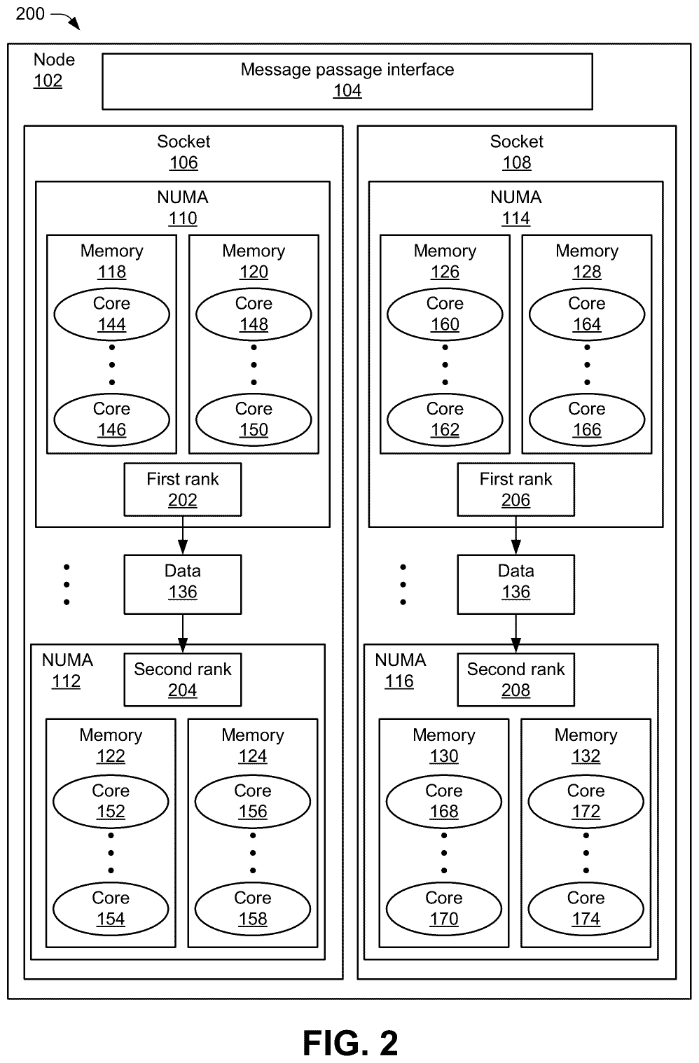

FIG. 2 is a block diagram of a non-limiting example implementation 200 of the MPI processing system of FIG. 1 in greater detail.

Consider an illustrative example scenario of the implementation 200 where the message passing interface 104 selects the NUMA affinity domain that includes the NUMA 110 to the NUMA 116. In one or more examples, the message passing interface 104 selects the NUMAs 110 and 112 as a first set of NUMA affinity domain partitions and selects the NUMAs 114 and 116 as a second set of NUMA affinity domain partitions. In one or more variations, the message passing interface 104 selects a first rank 202 (e.g., root rank) of a first process of communicating the data 136 as a leader rank over all NUMAs of the socket 106, and as a first NUMA partition leader rank and an affinity domain leader rank of the overall NUMA affinity domain within the socket 106. In one or more variations, the message passing interface 104 selects a first rank 206 (e.g., root rank) of a second process of communicating the data 136 as a first NUMA partition leader rank and a leader rank over all NUMA partitions of the socket 108. In one or more examples, the first rank 202 is equivalent to the first rank 134 of FIG. 1, and the first rank 206 is equivalent to the second rank 138 of FIG. 1. In one or more examples, the second rank 204 is a leader rank of the NUMA 112 and the second rank 208 is a leader rank of the NUMA 116. Additionally or alternatively, the second rank 204 is also the leader rank of the memory 122, and the leader rank of the core 152. Additionally or alternatively, the second rank 208 is also the leader rank of the memory 130, and the leader rank of the core 168.

In one or more examples, the message passing interface 104 selects a second rank 204 of a second process of communicating the data 136 that is assigned to the NUMA 112 of the NUMA affinity domain as a second NUMA partition leader rank. In one or more variations, the message passing interface 104 selects a second rank 208 of a second process of communicating the data 136 that is assigned to the NUMA 116 of the NUMA affinity domain as a second NUMA partition leader rank.

In one or more variations, the first rank 202, as the first NUMA partition affinity domain leader rank within socket 106, receives the data 136 before any other rank among the NUMA partitions of the socket 106 (e.g., when the first rank 202 is the partition leader rank of the socket 106). In one or more variations, the first rank 206, as the first NUMA partition affinity domain leader rank within socket 108, receives the data 136 before any other rank among the NUMA partitions of the socket 108.

In one or more examples, the first rank 202 receives the data 136 from a leader rank of the socket 106 (e.g., the first rank 202 is equivalent to the first rank 134 of FIG. 1), and the first rank 206 receives the data 136 from a leader rank of the socket 108 (e.g., the second rank 206 is equivalent to the second rank 138 of FIG. 1). The reception of the data 136 at the first rank 202 is based on the selection of the first rank 202 as the affinity domain leader rank for the first NUMA partition affinity domain of the socket 106. The reception of the data 136 at the first rank 206 is based on the selection of the first rank 206 as the affinity domain leader rank for the first NUMA partition affinity domain of the socket 108. Additionally or alternatively, reception of the data 136 at the first rank 202 is based on the first rank 202 being mapped to a first virtual affinity domain leader rank (e.g., the virtual leader rank over all ranks within the NUMA 110 to the NUMA 112). Similarly, reception of the data 136 at the first rank 206 is based on the first rank 206 being mapped to a first virtual affinity domain leader rank (e.g., the virtual leader rank over all ranks within the NUMA 114 to the NUMA 116).

Accordingly, the virtual affinity domain leader rank over the socket affinity domain of the socket 106 communicates the data 136 to the first virtual affinity domain leader rank of the socket 108 as illustrated in FIG. 1. Similarly, the virtual affinity domain leader rank over the socket affinity domain of the NUMA 110 communicates the data 136 to the virtual affinity domain leader rank of the NUMA 112 as illustrated in FIG. 2.

In one or more implementations, the communication of the data 136 from the first rank 202 (e.g., the first partition leader rank of the first NUMA partition of the socket 106) to the second rank 204 (e.g., the second partition leader rank of the second NUMA partition of the socket 106) is based on the message passing interface 104 selecting the first rank 202 as the first NUMA partition affinity domain leader rank (e.g., the leader rank over all ranks within the NUMA 110 to the NUMA 112) and selecting the second rank 204 as a subordinate NUMA leader rank (e.g., the leader rank over all ranks within the NUMA 112 and subordinate to the leader rank status of the first rank 202). Similarly, the communication of the data 136 from the first rank 206 (e.g., the first partition leader rank of the first NUMA partition of the socket 108) to the second rank 208 (e.g., the second partition leader rank of the second NUMA partition of the socket 106) is based on the message passing interface 104 selecting the first rank 206 as the first NUMA partition affinity domain leader rank (e.g., the leader rank over all ranks within the NUMA 114 to the NUMA 116) and selecting the second rank 208 as a subordinate NUMA leader rank (e.g., the leader rank over all ranks within the NUMA 116 and subordinate to the leader rank status of the first rank 206).

In one or more variations, the communication of the data 136 from the first partition leader rank of the NUMAs within the socket 106 (e.g., the first rank 202) to the second partition leader rank (e.g., the second rank 204) is based on the first rank 202 being mapped, by the message passing interface 104, to a virtual first partition leader rank and the second rank 204 being mapped, by the message passing interface 104, to a virtual second partition leader rank subordinate to the virtual first partition leader rank. Similarly, the communication of the data 136 from the first partition leader rank of the NUMAs within the socket 108 (e.g., the first rank 206) to the second partition leader rank (e.g., the second rank 208) is based on the first rank 206 being mapped, by the message passing interface 104, to a virtual first partition leader rank and the second rank 208 being mapped, by the message passing interface 104, to a virtual second partition leader rank subordinate to the virtual first partition leader rank.

In one or more examples, the communication of the data 136 from the first rank 202 as the first partition leader rank to each of the one or more first partition subordinate ranks is based on the message passing interface 104 mapping the first partition leader rank (e.g., the first rank 202) to a virtual first partition leader rank, and mapping each of the one or more subordinate ranks of the NUMA 110 to respective virtual first partition subordinate ranks. In one or more examples, the message passing interface 104 maps each of one or more second partition subordinate ranks (e.g., ranks of the NUMA 112) to respective virtual second partition subordinate ranks. The message passing interface 104 communicates the data from the virtual second partition leader rank to the respective virtual second partition subordinate ranks.

In one or more variations, the first rank 202 is a leader rank of the socket 106, the leader rank of the NUMA 110, the leader rank of the memory 118, and the leader rank of the core 144. Accordingly, the data 136 being received at the socket 106 makes the data 136 available to the leader rank of the NUMA 110 (e.g., the first rank 202) as well as to the leader rank of the memory 118 and the leader rank of the core 144.

The message passing logic provides several advantages. Because the message passing logic generally limits data transfers to the leader ranks of the respective affinity domains except at the lowest affinity domain level, the message passing logic reduces high-latency communication because the data transfer latency within the higher affinity domain levels (e.g., the NUMA 110 to the NUMA 112) is higher than that within the lowest affinity domain level (e.g., within Memory 118 of NUMA 110).

It is to be appreciated that the message passing logic is applicable in connection with a variety of MPI collective operations across one or more nodes and that involve multiple applications, processing units, memories, logic controllers, and/or a variety of processor architectures.

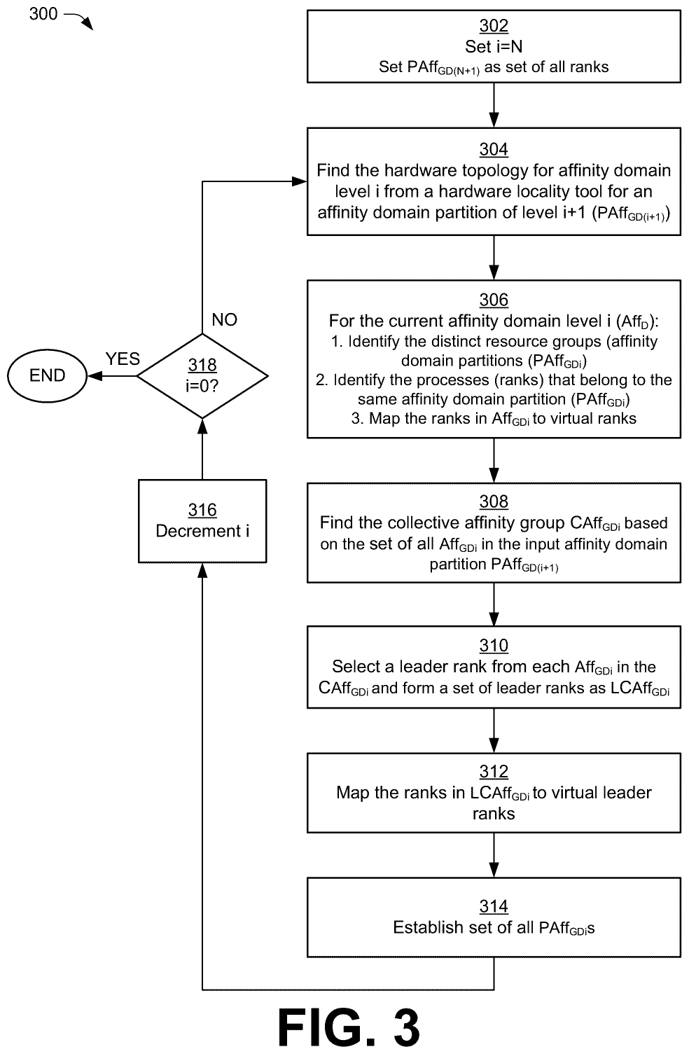

FIG. 3 is a flow diagram depicting an algorithm as a step-by-step procedure 300 in another example of implementing an MPI processing system configured to perform mapping-aware and memory topology-aware MPI collectives.

In one or more implementations, the message passing logic includes an instantiation stage and/or a communication stage. The instantiation stage is where the affinity associations are formed (e.g., affinity domains, affinity domain partitions, affinity groups, collective affinity groups, leader ranks, leader groups, collective leaders, etc.). The communication stage is where the data transfer is done in a hierarchical manner according to the affinity associations. The procedure 300 provides one example of the instantiation stage (e.g., a general flow of the instantiation stage).

The variable i (e.g., affinity domain level) is set equal to N, and the affinity domain partition PAff_{GD(N+1)} is identified as the set of all ranks (block 302). N is the number of available affinity levels for a given communicator (e.g., the number of active resource groups, the resource groups containing one or more ranks).

A hardware locality tool (e.g., hwloc) is used to identify affinity domains. The hardware topology for affinity domain level i is found from a hardware locality tool (e.g., hwloc) for an affinity domain partition of level i+1 (PAff_{GD(i+1)}) (block 304). For each affinity domain level i, the procedure 300 finds the number (Mᵢ) of partitions, where Mᵢ is the number of resource groups (e.g., active resource groups) at that level. In an example of the processor architecture of FIGS. 1 and 2, procedure 300 determines where each rank is bound to a core, that the number of node partitions (PAff_{GD4}) is one, that the number of socket partitions (PAff_{GD3}) for the given node partition is two, the number of NUMA partitions (PAff_{GD2}) for each given socket partition is four, and the number of memory partitions (PAff_{GD1}) for each given NUMA partition is 2. For single-node cases, the number of node partitions is one and for multi-node cases, the number of node partitions is two or more.

For the current affinity domain level i (Aff_{Di}), the distinct resource groups (affinity domain partitions (PAff_{GDi}) are identified, the processes (ranks) that belong to the same affinity domain partition (PAff_{GDi}) are identified, and the ranks in PAff_{GDi} to virtual ranks are mapped (block 306). For each partition pᵢⱼ of PAff_{GDi}, procedure 300 maps the ranks to virtual ranks (VR), with virtual rank varying from 0, 1, . . . , Lᵢⱼ−1, where i is the affinity domain level, i=1, 2, . . . , N, j is the partition index, j=1, 2, . . . , Mᵢ, and Lᵢⱼ is the number of ranks in partition pᵢⱼ. Procedure 300 chooses one rank of pᵢⱼ as the leader rank (e.g., virtual rank 0).

The collective affinity group CAff_{GDi} is determined based on the set of all Aff_{GDi} in the input affinity domain partition PAff_{GD(i+1)} (block 308). For example, procedure 300 determines all of the processes mapped to a given affinity domain partition.

A leader rank from each affinity group Aff_{GDi} in the collective affinity group CAff_{GDi} is selected and a set of leader ranks are formed as LCAff_{GDi} (block 310). For example, a leader rank of the NUMA 110 (e.g., the first rank 202) is selected among the ranks of the first NUMA partition, and a leader rank of the NUMA 114 (e.g., the first rank 206) is selected among the ranks of the second NUMA partition.

The ranks in LCAff_{GDi} are mapped to virtual leader ranks (block 312). For example, the procedure 300 creates the group of leader ranks LCAff_{GDi} for affinity domain level i, with the leader ranks mapped to virtual leader ranks (VLRs). In one or more examples, the procedure 300 selects one of these leader ranks as a local root rank (leader virtual rank 0).

A set of all affinity domain partitions PAff_{GDi}s are established for a given iteration of i (block 314). The variable i is then decremented (block 316). It is determined whether the variable i is decremented to equal zero (block 318). When the variable i is determined not to be decremented to equal zero, then procedure 300 goes to block 304. When the variable i is decremented to equal zero, the procedure 300 ends.

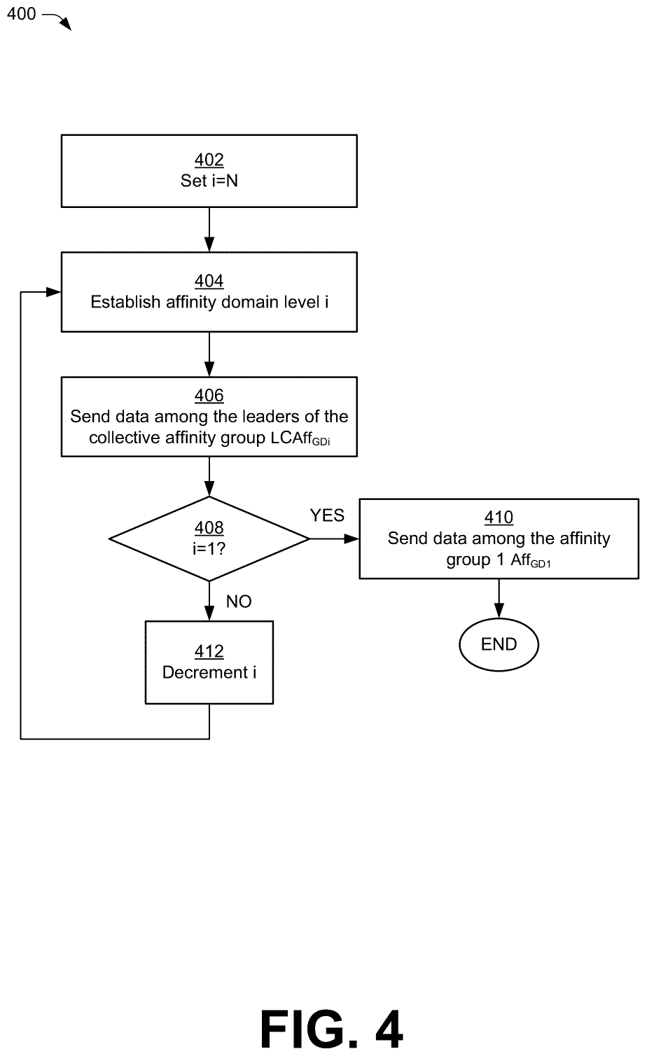

FIG. 4 is a flow diagram depicting an algorithm as a step-by-step procedure 400 in another example of implementing an MPI processing system configured to perform mapping-aware and memory topology-aware MPI collectives.

In one or more implementations, the message passing logic includes an instantiation stage and/or a communication stage. The instantiation stage is where the affinity associations are formed (e.g., affinity domains, affinity domain partitions, affinity groups, collective affinity groups, leader ranks, leader groups, collective leaders, etc.). The communication stage is where the data transfer is done in a hierarchical manner according to the affinity associations. The procedure 400 provides one example of the communication stage. Procedure 400 is an example of a one-to-all MPI collective function (e.g., MPI broadcast).

The variable i is set equal to N (block 402). N is the number of available affinity levels for a given communicator (e.g., the number of active resource groups). Starting with resource group level i=N, procedure 400 iterates down to i=1.

The affinity domain level i is established (block 404). For example, for each iteration of the variable i from i=N to i=1, the procedure 400 establishes a given affinity domain level (e.g., of FIGS. 1 and 2, the affinity domain level of socket 106, the affinity domain level of NUMA 110, or the affinity domain level of memory 118, etc.).

Data is sent among the leaders of the collective affinity group LCAff_{GDi} (block 406). Procedure 400 performs data communication (e.g., send/receive) across only the leader ranks of the Mᵢ number of partitions. For example, procedure 400 communicates data across the virtual leader ranks (VLR0, VLR1, . . . , VLRMᵢ₋₁) for a given affinity domain level i (e.g., resource group level i). For example, procedure 400 communicates data from the leader rank of the memory 118 to the leader rank of the memory 120. Similarly, procedure 400 communicates data from the leader rank of the memory 126 to the leader rank of the memory 128. Thus, cross-partition data transfer is limited to Mᵢ at the given affinity domain level i.

It is determined whether the variable i is equal to one (block 408). When the variable i is equal to one, the data is distributed among the affinity group one (Aff_{GD1}) (block 410). For affinity domain level 1 (e.g., resource group level 1), procedure 400 performs data communication (send/receive) across all the ranks within each of the Mᵢ number of partitions. i.e., perform send/receive across VR0, VR1, . . . , VR (Lᵢⱼ₋₁), for partition pᵢⱼ. For example, the leader rank of the memory 118 communicates data to each of the other ranks of memory 118 (e.g., to each subordinate rank under the leader rank of the memory 118). When the variable i is not equal to one, then the variable i is decremented and the procedure 400 goes to block 404 (block 412).

It should be understood that many variations are possible based on the disclosure herein. Although features and elements are described above in particular combinations, each feature or element is usable alone without the other features and elements or in various combinations with or without other features and elements.

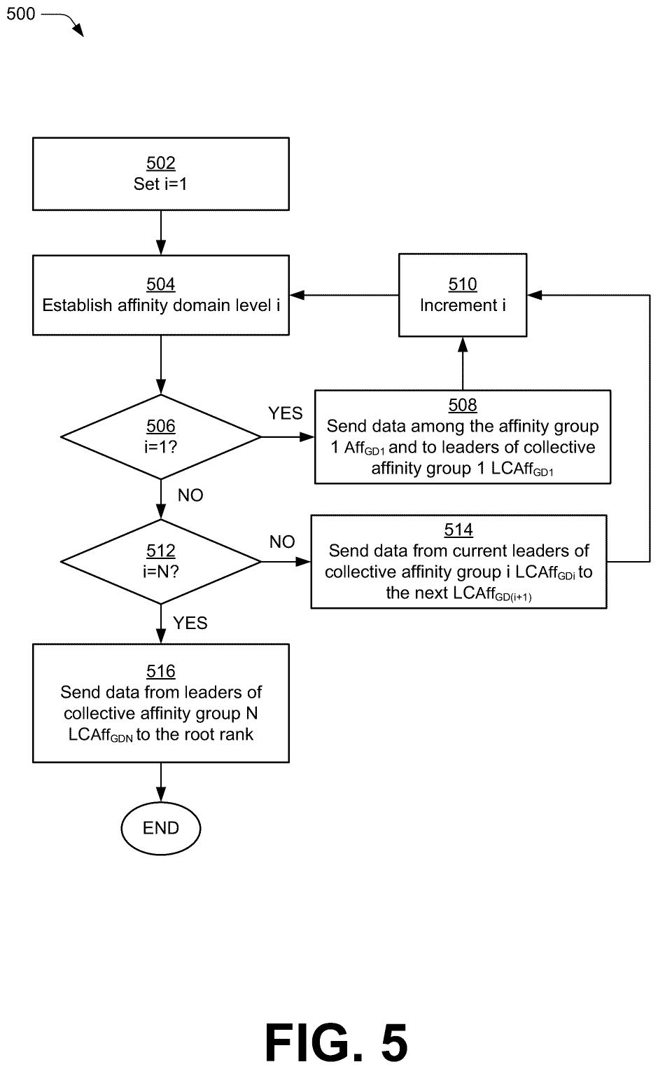

FIG. 5 is a flow diagram depicting an algorithm as a step-by-step procedure 500 in an example of implementing an MPI processing system configured to perform mapping-aware and memory topology-aware MPI collectives. In one or more implementations, at least a portion of the procedure 500 is executed as a part of the procedure 400 of FIG. 4. In one or more variations, the procedure 400 is performed in conjunction with procedure 500 (e.g., for all-to-all communication). Alternatively, the procedure 500 is executed separately from the procedure 400.

In one or more implementations, the message passing logic includes an instantiation stage and/or a communication stage. The instantiation stage is where the affinity associations are formed (e.g., affinity domains, affinity domain partitions, affinity groups, collective affinity groups, leader ranks, leader groups, collective leaders, etc.). The communication stage is where the data transfer is done in a hierarchical manner according to the affinity associations. The procedure 500 provides one example of the communication stage. The procedure 500 provides one example of the communication stage. Procedure 500 is an example of an all-to-one MPI collective function (e.g., MPI gather).

The variable i is set equal to 1 (block 502). Starting with resource group level i=1, procedure 500 iterates up to i=N. N is the number of available affinity levels for a given communicator (e.g., the number of active resource groups).

Affinity domain level i is established (block 504). For example, for each iteration of the variable i from i=1 to i=N, the procedure 500 establishes a given affinity domain level.

It is determined whether the variable i is equal to one (block 506). When the variable i is equal to one, data is distributed among the affinity group 1 Aff_{GD1} and to the leaders of collective affinity group 1 LCAff_{GD1} (block 508). The variable i is then incremented and the procedure 500 goes to block 504 (block 510).

It is determined whether the variable i is equal to N (block 512). When the variable i is determined not to equal N, data from the current leaders of the collective affinity group i LCAff_{GDi} are sent to the next LCAff_{GD(i+1)} (block 514). The variable i is then incremented and the procedure 500 goes to block 504 (block 510).

When the variable i is determined to equal N, data from the leaders of the collective affinity group N LCAff_{GDN} are sent to the root rank (block 516). The procedure 500 then ends.

It is noted that MPI collective functions may be performed in a forward order for one-to-all communication (e.g., procedure 400), in a reverse order for all-to-one communication (e.g., procedure 500), or in both the forward and the reverse order for all-to-all communication (e.g., procedure 400 and procedure 500).

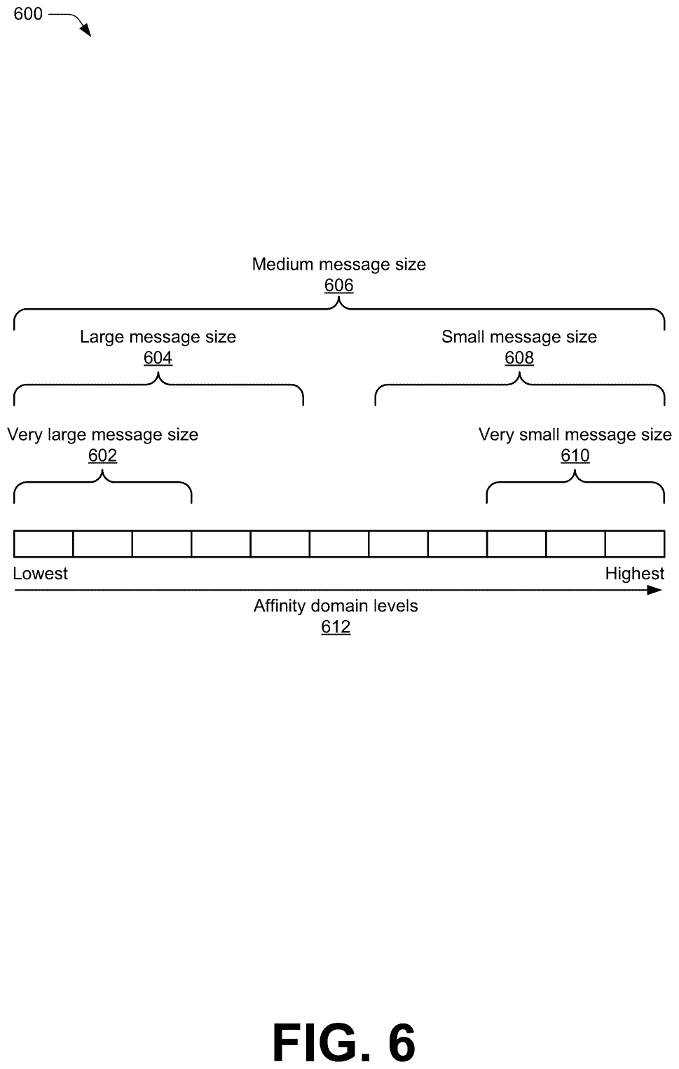

FIG. 6 is a block diagram of a non-limiting example 600 implementation of message size relative to an example of implementing the MPI processing system of FIGS. 1 and/or 2.

In one or more implementations, which affinity domains are available determined based on the hardware topology and rank distribution. Additionally or alternatively, which affinity domains are available determined based on the message size associated with the data (e.g., the data 136 of FIGS. 1 and 2).

The message sizes may be divided into two or more sizes. In the illustrated example, the message sizes are divided into a very large message size 602, a large message size 604, a medium message size 606, a small message size 608, and a very small message size 610. The affinity domain levels 612 are shown from lowest to highest. As shown the various message sizes may be associated with different affinity domain levels 612. In the illustrated example, the very large message size 602 is associated with one or more of the lowest of the affinity domains levels 612, the large message size 604 is associated with more levels of the affinity domains levels 612 than the large message size 604, and the medium message size 606 is associated with a majority of the levels of the affinity domains levels 612 (e.g., all of the levels of the affinity domains levels 612). The small message size 608 is associated with one or more of the highest of the affinity domains levels 612, and the very small message size 610 is associated with less levels of the affinity domains levels 612 than the small message size 608.

In one or more examples, each message size is associated with a threshold. In one or more variations, each threshold is set by the message passing logic described herein. In one or more non-limiting examples, the very large message size 602 indicates a message size that exceeds a first threshold of 100 megabytes, the large message size 604 indicates a message size that exceeds a second threshold of 1 megabyte, the medium message size 606 indicates a message size that exceeds a third threshold of 1 kilobyte, the small message size 608 indicates a message size that exceeds a fourth threshold of 100 bytes, and the very small message size 610 indicates a message size that falls below the fourth threshold of 100 bytes. The indicated thresholds are non-limiting. One or more examples, include one or more different thresholds for message sizes. In one or more variations, more or less thresholds are implemented (e.g., more or less message size ranges).

For the very small message size 610, using affinity domains down to the lowest available affinity domain degrades MPI performance because the overhead of the additional communication hops often offsets the actual transmission time. Thus, for the very small message size 610, the lowest available affinity domain is chosen among the highest affinity domain levels. Thus, when the message size is below the fourth threshold of 100 bytes, communication is performed at the highest levels (e.g., at the socket and node levels, or only at the node level). When the message size exceeds the first threshold of 100 megabytes, communication is performed at the lowest levels (e.g., at the memory and core levels, or only at the core level).

As the message size increases, the lowest available affinity domain is chosen among lower and lower affinity domain levels, up until the medium message size 606 is reached, where a majority of the affinity domain levels are used (e.g., all of the affinity domain levels). As the message size increases beyond the medium message size 606, the highest available affinity domain is selected among the lowest affinity domain levels. For the large message size 604 and the very large message size 602, the highest available affinity domain is chosen among the lowest affinity domain levels to reduce the data transfer overheads due to the additional communication hops.

Accordingly, the selection of available affinity domains is based on processor architecture, a mapping of processes of the message passing interface to hardware resources of the node, and/or a size of the data.

In one or more implementations, the message passing logic includes selecting topology for a given affinity domain based on message size. In one or more examples, the message passing logic includes selecting a tree topology separately for each affinity domain depending on the message size and the latency across leader rank cores. When the message size is relatively small (e.g., small message size 608 and/or very small message size 610), the message passing logic uses a binomial topology or k-nomial tree-based topology instead of a flat tree topology. When the latency across leader rank cores is relatively high (e.g., corresponding to higher levels of affinity domain such as nodes or sockets) and varies across any two pairs, the message passing logic includes selecting a binomial topology or k-nomial tree-based topology instead of a flat tree topology.

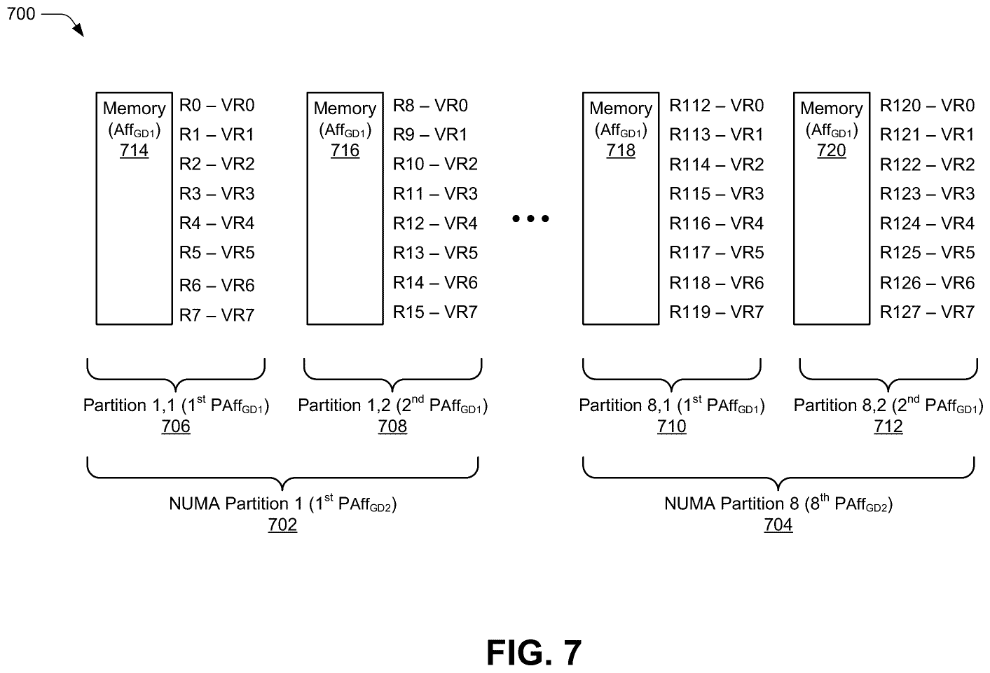

FIG. 7 is a block diagram of a non-limiting example implementation of mapping and topology awareness in an example of implementing the MPI processing system of FIGS. 1 and/or 2.

In the illustrated example, implementation 700 depicts two NUMA partitions of eight total NUMA partitions within a given socket partition (e.g., NUMA 110 to NUMA 112 within socket 106 of FIG. 1). In particular, implementation 700 depicts the first NUMA partition 702 (PAff_{GD2}) and the eighth NUMA partition 704 (PAff_{GD2}). The first NUMA partition 702 includes a first memory partition 706 (PAff_{GD1}) and a second memory partition 708 (PAff_{GD1}). The eighth NUMA partition 704 includes a first memory partition 710 (PAff_{GD1}) and a second memory partition 712 (PAff_{GD1}). As shown, the first memory partition 706 includes a memory 714 (AFF_{GD1}) and the second memory partition 708 includes a memory 716 (AFF_{GD1}). Also, the first memory partition 710 includes a memory 718 (AFF_{GD1}) and the second memory partition 712 includes a memory 720 (AFF_{GD1}).

Implementation 700 depicts a ranks-to-virtual ranks mapping and leader ranks for a processor architecture with 128 processes and two active affinity domains of memory and eight NUMA affinity domains, where, Lᵢⱼ=8 (e.g., eight NUMA partitions per socket), and M₁=2 (e.g., two memory partitions per NUMA).

The 128 processes are distributed among the memory partitions of each NUMA partition. With eight NUMA partitions and two memory partitions per NUMA, each NUMA is assigned 16 processes, and the 16 processes of each NUMA are distributed among the two memory partitions. Accordingly, eight processes are assigned to the first memory partition 706, eight processes are assigned to the second memory partition 708, eight processes are assigned to the first memory partition 710, and eight processes are assigned to the second memory partition 712.

In the illustrated example, the processes of the first memory partition 706 (e.g., the memory 714) are ranked from R0 to R7, the processes of the second memory partition 708 (e.g., the memory 716) are ranked from R8 to R15, the processes of the first memory partition 710 (e.g., the memory 718) are ranked from R112 to R119, and the processes of the second memory partition 712 (e.g., the memory 720) are ranked from R120 to R127. The remaining processes of the 128 processes are distributed among memory partitions of the second to seventh NUMA partitions (not shown).

Based on the message passing logic, the ranks of each memory partition are mapped to virtual ranks. As depicted, the ranks R0 to R7 of the first memory partition 706 are mapped to virtual ranks VR0 to VR7. Similarly, the ranks R8 to R15 of the second memory partition 708 are mapped to virtual ranks VR0 to VR7, the ranks R112 to R119 of the first memory partition 710 are mapped to virtual ranks VR0 to VR7, and the ranks R120 to R127 of the second memory partition 712 are mapped to virtual ranks VR0 to VR7. Thus, each memory partition is mapped with local virtual ranks VR0 to VR7.

In the illustrated example, VR0 of the first memory partition 706 is a virtual leader rank LVR0 of the first memory partition 706 (e.g., root rank of the eight NUMA partitions). Simultaneously, VR0 of the first memory partition 706 is a virtual leader rank LVR0 of the first NUMA partition 702. The virtual leader rank LVR0 of the first NUMA partition 702 is an overall virtual leader rank (LCAff_{GD2}) for the eight NUMA partitions (CAff_{GD2}). Accordingly, for a one-to-all MPI collective function, LVR0 of the first NUMA partition 702 includes the data from the virtual leader rank of the socket level that encapsulates the eight NUMA partitions 702 to 704 (e.g., LVR0 is equivalent to the virtual leader rank of the socket level encapsulating the eight NUMA partitions 702 to 704). LVR0 of the first NUMA partition 702 then distributes the data to the virtual leaders ranks of each of the other NUMA partitions. For example, LVR0 mapped to R0 is the virtual leader rank of the first NUMA partition 702, LVR1 mapped to R16 of a second NUMA partition (not shown) is the virtual leader rank of the second NUMA partition, LVR2 mapped to R32 of a third NUMA partition (not shown) is the virtual leader rank of the third NUMA partition, LVR3 mapped to R48 of a fourth NUMA partition (not shown) is the virtual leader rank of the fourth NUMA partition, LVR4 mapped to R64 of a fifth NUMA partition (not shown) is the virtual leader rank of the fifth NUMA partition, LVR5 mapped to R80 of a sixth NUMA partition (not shown) is the virtual leader rank of the sixth NUMA partition, LVR6 mapped to R96 of a seventh NUMA partition (not shown) is the virtual leader rank of a seventh NUMA partition, and LVR7 mapped to R112 is the virtual leader rank of the eighth NUMA partition 704. Accordingly, LVR0 of the first NUMA partition 702 receives the data for all eight NUMA partitions, and then LVR0 of the first NUMA partition 702 distributes the data to the group of virtual leader ranks of the other seven NUMA partitions (e.g., LVR1 to LVR7).

As indicated, VR0 of the first memory partition 706 is also the virtual leader rank LVR0 of the first memory partition 706. Accordingly, LVR0 mapped to R0 receives the data and distributes the data to the leader virtual ranks of each memory partition of each of the other seven NUMA partitions. In one or more examples, one rank from each memory within each of the eight NUMA partitions is selected as a local memory virtual leader rank. For example, R0 of the memory 714 is mapped to LVR0 of the first memory partition 706 and R8 of the memory 716 is mapped to LVR1 of the second memory partition 708. Similarly, R16 of a first memory of the second NUMA partition is mapped to LVR0 of the respective first memory and R24 of a second memory of the second NUMA partition is mapped to LVR1 of the respective second memory. R32 of a first memory of the third NUMA partition is mapped to LVR0 of the respective first memory and R40 of a second memory of the third NUMA partition is mapped to LVR1 of the respective second memory. R48 of a first memory of the fourth NUMA partition is mapped to LVR0 of the respective first memory and R56 of a second memory of the fourth NUMA partition is mapped to LVR1 of the respective second memory. R64 of a first memory of the fifth NUMA partition is mapped to LVR0 of the respective first memory and R72 of a second memory of the fifth NUMA partition is mapped to LVR1 of the respective second memory. R80 of a first memory of the sixth NUMA partition is mapped to LVR0 of the sixth NUMA partition and R88 of a second memory of the sixth NUMA partition is mapped to LVR1 of the respective second memory. R96 of a first memory of the seventh NUMA partition is mapped to LVR0 of the respective first memory and R104 of a second memory of the seventh NUMA partition is mapped to LVR1 of the respective second memory. R112 of the memory 718 is mapped to LVR0 of the first memory partition 710 and R120 of the memory 720 is mapped to LVR1 of the second memory partition 712.

In one or more variations, LVR0 mapped to R0 receives the data and distributes the data to R8 (VR0) of the second memory partition 708. LVR0 mapped to R0 also distributes the data to the subordinate virtual ranks VR1, VR2, VR3, VR4, VR5, VR6, and VR7 of the first memory partition 706. The virtual leader rank of each memory partition receives the data and distributes the data accordingly. Thus, VR0 mapped to R8 of the second memory partition 708 receives the data and distributes the data to the subordinate virtual ranks VR1, VR2, VR3, VR4, VR5, VR6, and VR7 of the second memory partition 708. Similarly, LVR0 mapped to R112 receives the data and distributes the data to R120 (VR0) of the second memory partition 712. LVR0 mapped to R112 also distributes the data to the subordinate virtual ranks VR1, VR2, VR3, VR4, VR5, VR6, and VR7 of the first memory partition 710. VR0 mapped to R120 of the second memory partition 712 receives the data and distributes the data to the subordinate virtual ranks VR1 to VR7 of the second memory partition 712.

VR0 of the first memory partition 706 is also the virtual leader rank LVR0 of the first memory partition 706. Accordingly, LVR0 mapped to R0 receives the data and distributes the data to R8 of the second memory partition 708. LVR0 also distributes the data to the subordinate virtual ranks VR1 to VR7 of the first memory partition 706, and VR0 of the second memory partition 708 distributes the data to the subordinate virtual ranks VR1 to VR7 of the second memory partition 708. The virtual leader rank of each memory partition receives the data and distributes the data accordingly.

Accordingly, performance of MPI collectives on various architectures is improved by making the collective functions aware of the underlying topology and the message passing logic provides a framework for obtaining optimal performance with MPI collectives on various processor architectures.

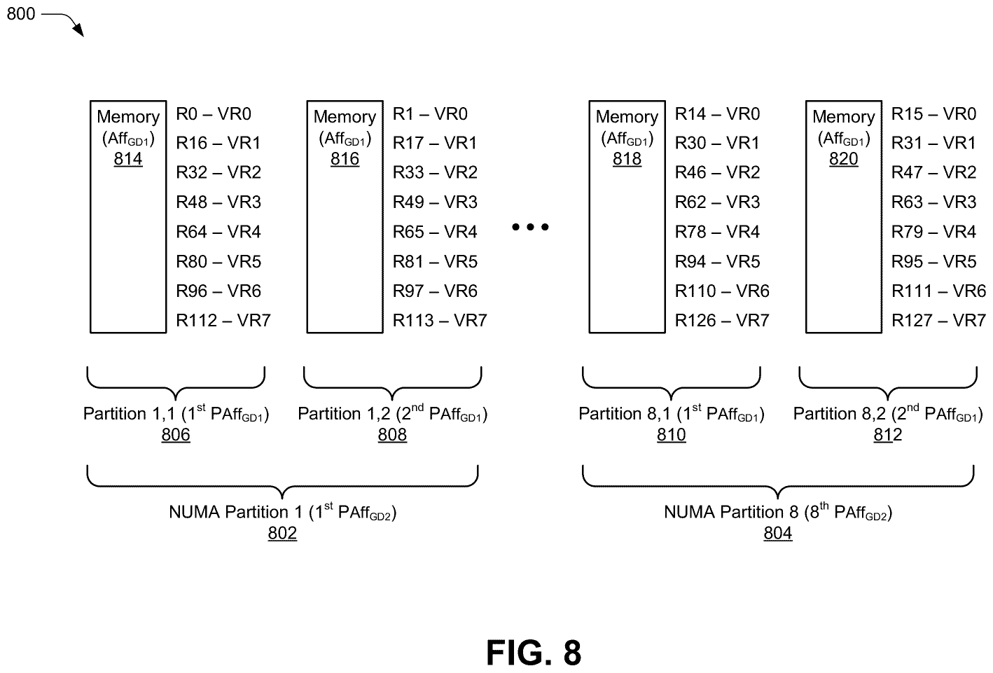

FIG. 8 is a block diagram of a non-limiting example implementation of mapping and topology awareness in an example of implementing the MPI processing system of FIGS. 1 and/or 2.

In the illustrated example, implementation 800 depicts two NUMA partitions of eight total NUMA partitions within a given socket partition (e.g., NUMA 110 to NUMA 112 within socket 106 of FIG. 1). In particular, implementation 800 depicts the first NUMA partition 802 (PAff_{GD2}) and the eighth NUMA partition 804 (PAff_{GD2}). The first NUMA partition 802 includes a first memory partition 806 (PAff_{GD1}) and a second memory partition 808 (PAff_{GD1}). The eighth NUMA partition 804 includes a first memory partition 810 (PAff_{GD1}) and a second memory partition 812 (PAff_{GD1}). As shown, the first memory partition 806 includes a memory 814 (AFF_{GD1}) and the second memory partition 808 includes a memory 816 (AFF_{GD1}). Also, the first memory partition 810 includes a memory 818 (AFF_{GD1}) and the second memory partition 812 includes a memory 820 (AFF_{GD1}).

Implementation 800 depicts a ranks-to-virtual ranks mapping and leader ranks for a processor architecture with 128 processes and two active affinity domains of memory and eight NUMA affinity domains, where, Lᵢⱼ=8 (e.g., eight NUMA partitions per socket), and M₁=2 (e.g., two memory partitions per NUMA).

Implementation 800 depicts a rank assignment where the processes of the memory 814 are assigned the ranks R0, R16, R32, R48, R64, R80, R96, and R112. The processes of the memory 816 are assigned the ranks R1, R17, R33, R49, R65, R81, R97, and R113. The processes of the memory 818 are assigned the ranks R14, R30, R46, R62, R78, R94, R110, and R126. The processes of the memory 820 are assigned the ranks R15, R31, R47, R63, R79, R95, R111, and R127.

In the illustrated example, the ranks of the memories 814, 816, 818, and 820 are respectively mapped to VR0 to VR7. In the illustrated example, VR0 of the first memory partition 806 is a virtual leader rank LVR0 of the first memory partition 806 (e.g., root rank of the eight NUMA partitions). Simultaneously, VR0 of the first memory partition 806 is a virtual leader rank LVR0 of the first NUMA partition 802. The virtual leader rank LVR0 of the first NUMA partition 802 is an overall virtual leader rank (LCAff_{GD2}) for the eight NUMA partitions (CAff_{GD2}). Accordingly, for a one-to-all MPI collective function, LVR0 of the first NUMA partition 802 includes the data from the virtual leader rank of the socket level that encapsulates the eight NUMA partition 802 to 804 (e.g., LVR0 is equivalent to the virtual leader rank of the socket level encapsulating the eight NUMA partitions 802 to 804). LVR0 of the first NUMA partition 802 distributes the data to the virtual leaders ranks of each of the other NUMA partitions.

In one or more examples, LVR0 mapped to R0 is the virtual leader rank of the first NUMA partition 802, LVR1 mapped to R2 of a second NUMA partition (not shown) is the virtual leader rank of the second NUMA partition, LVR2 mapped to R4 of a third NUMA partition (not shown) is the virtual leader rank of the third NUMA partition, LVR3 mapped to R6 of a fourth NUMA partition (not shown) is the virtual leader rank of the fourth NUMA partition, LVR4 mapped to R8 of a fifth NUMA partition (not shown) is the virtual leader rank of the fifth NUMA partition, LVR5 mapped to R10 of a sixth NUMA partition (not shown) is the virtual leader rank of the sixth NUMA partition, LVR6 mapped to R12 of a seventh NUMA partition (not shown) is the virtual leader rank of a seventh NUMA partition, and LVR7 mapped to R14 is the virtual leader rank of the eighth NUMA partition 804. Accordingly, LVR0 of the first NUMA partition 802 receives the data for all eight NUMA partitions, and then LVR0 of the first NUMA partition 802 distributes the data to the group of virtual leader ranks of the other seven NUMA partitions, including the eighth NUMA partition 804 (e.g., regardless of the rank assignment, topology, etc.).

In one or more examples, one rank from each of the eight NUMA partitions is selected as a local memory virtual leader rank of each set of memory partitions. For example, R0 of the memory 814 is mapped to LVR0 of the first NUMA partition 802 and R1 of the memory 816 is mapped to LVR1 of the second memory partition 808. Similarly, R2 of a first memory of the second NUMA partition is mapped to LVR0 of the respective first memory and R3 of a second memory of the second NUMA partition is mapped to LVR1 of the respective second memory. R4 of a first memory of the third NUMA partition is mapped to LVR0 of the respective first memory and R5 of a second memory of the third NUMA partition is mapped to LVR1 of the respective second memory. R6 of a first memory of the fourth NUMA partition is mapped to LVR0 of the respective first memory and R7 of a second memory of the fourth NUMA partition is mapped to LVR1 of the respective second memory. R8 of a first memory of the fifth NUMA partition is mapped to LVR0 of the respective first memory and R9 of a second memory of the fifth NUMA partition is mapped to LVR1 of the respective second memory. R10 of a first memory of the sixth NUMA partition is mapped to LVR0 of the sixth NUMA partition and R11 of a second memory of the sixth NUMA partition is mapped to LVR1 of the respective second memory. R12 of a first memory of the seventh NUMA partition is mapped to LVR0 of the respective first memory and R13 of a second memory of the seventh NUMA partition is mapped to LVR1 of the respective second memory. R14 of the memory 718 is mapped to LVR0 of the eighth NUMA partition 704 and R15 of the memory 720 is mapped to LVR1 of the eighth NUMA partition 704.

The message passing logic distributes the data according to the virtual ranks and virtual leader ranks and virtual subordinate ranks of implementation 800 at least in the way data is distributed as described with reference to implementation 700.

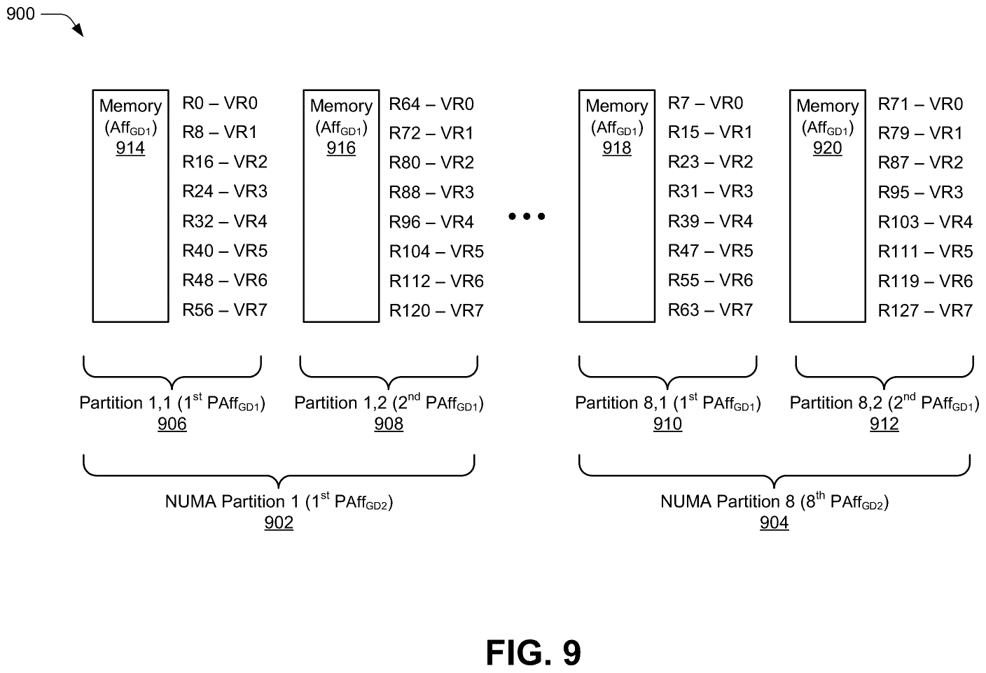

FIG. 9 is a block diagram of a non-limiting example implementation of mapping and topology awareness in an example of implementing the MPI processing system of FIGS. 1 and/or 2.

In the illustrated example, implementation 900 depicts two NUMA partitions of eight total NUMA partitions within a given socket partition (e.g., NUMA 110 to NUMA 112 within socket 106 of FIG. 1). In particular, implementation 900 depicts the first NUMA partition 902 (PAff_{GD2}) and the eighth NUMA partition 904 (PAff_{GD2}). The first NUMA partition 902 includes a first memory partition 906 (PAff_{GD1}) and a second memory partition 908 (PAff_{GD1}). The eighth NUMA partition 904 includes a first memory partition 910 (PAff_{GD1}) and a second memory partition 912 (PAff_{GD1}). As shown, the first memory partition 906 includes a memory 914 (AFF_{GD1}) and the second memory partition 908 includes a memory 916 (AFF_{GD1}). Also, the first memory partition 910 includes a memory 918 (AFF_{GD1}) and the second memory partition 912 includes a memory 920 (AFF_{GD1}).

Implementation 900 depicts a ranks-to-virtual ranks mapping and leader ranks for a processor architecture with 128 processes and two active affinity domains of memory and eight NUMA affinity domains, where, Lᵢⱼ=8 (e.g., eight NUMA partitions per socket), and M₁=2 (e.g., two memory partitions per NUMA).

Implementation 900 depicts a rank assignment where the processes of the memory 914 are assigned the ranks R0, R8, R16, R24, R32, R40, R48, and R56. The processes of the memory 916 are assigned the ranks R64, R72, R80, R88, R96, R104, R112, and R120. The processes of the memory 918 are assigned the ranks R7, R15, R23, R31, R39, R47, R55, and R63. The processes of the memory 920 are assigned the ranks R71, R79, R87, R95, R103, R111, R119, and R127.

In the illustrated example, the ranks of the memories 914, 916, 918, and 920 are respectively mapped to VR0 to VR7. In the illustrated example, VR0 of the first memory partition 906 is a virtual leader rank LVR0 of the first memory partition 906 (e.g., root rank of the eight NUMA partitions). Simultaneously, VR0 of the first memory partition 906 is a virtual leader rank LVR0 of the first NUMA partition 902. The virtual leader rank LVR0 of the first NUMA partition 902 is an overall virtual leader rank (LCAff_{GD2}) for the eight NUMA partitions (CAff_{GD2}). Accordingly, for a one-to-all MPI collective function, LVR0 of the first NUMA partition 902 includes the data from the virtual leader rank of the socket level that encapsulates the eight NUMA partition 902 to 904 (e.g., LVR0 is equivalent to the virtual leader rank of the socket level encapsulating the eight NUMA partitions 902 to 904). LVR0 of the first NUMA partition 902 distributes the data to the virtual leaders ranks of each of the other NUMA partitions.

In one or more examples, LVR0 mapped to R0 is the virtual leader rank of the first NUMA partition 902, LVR1 mapped to R1 of a second NUMA partition (not shown) is the virtual leader rank of the second NUMA partition, LVR2 mapped to R2 of a third NUMA partition (not shown) is the virtual leader rank of the third NUMA partition, LVR3 mapped to R3 of a fourth NUMA partition (not shown) is the virtual leader rank of the fourth NUMA partition, LVR4 mapped to R4 of a fifth NUMA partition (not shown) is the virtual leader rank of the fifth NUMA partition, LVR5 mapped to R5 of a sixth NUMA partition (not shown) is the virtual leader rank of the sixth NUMA partition, LVR6 mapped to R6 of a seventh NUMA partition (not shown) is the virtual leader rank of a seventh NUMA partition, and LVR7 mapped to R7 is the virtual leader rank of the eighth NUMA partition 904. Accordingly, LVR0 of the first NUMA partition 902 receives the data for all eight NUMA partitions, and then LVR0 of the first NUMA partition 902 distributes the data to the group of virtual leader ranks of the other seven NUMA partitions, including the eighth NUMA partition 904 (e.g., regardless of the rank assignment, topology, etc.).

In one or more examples, one rank from each of the eight NUMA partitions is selected as a local memory virtual leader rank of each set of memory partitions. For example, R0 of the memory 914 is mapped to LVR0 of the first NUMA partition 902 and R64 of the memory 916 is mapped to LVR1 of the second memory partition 908. Similarly, R1 of a first memory of the second NUMA partition is mapped to LVR0 of the respective first memory and R65 of a second memory of the second NUMA partition is mapped to LVR1 of the respective second memory. R2 of a first memory of the third NUMA partition is mapped to LVR0 of the respective first memory and R66 of a second memory of the third NUMA partition is mapped to LVR1 of the respective second memory. R3 of a first memory of the fourth NUMA partition is mapped to LVR0 of the respective first memory and R67 of a second memory of the fourth NUMA partition is mapped to LVR1 of the respective second memory. R4 of a first memory of the fifth NUMA partition is mapped to LVR0 of the respective first memory and R68 of a second memory of the fifth NUMA partition is mapped to LVR1 of the respective second memory. R5 of a first memory of the sixth NUMA partition is mapped to LVR0 of the respective first memory and R69 of a second memory of the sixth NUMA partition is mapped to LVR1 of the respective second memory. R6 of a first memory of the seventh NUMA partition is mapped to LVR0 of the respective first memory and R70 of a second memory of the seventh NUMA partition is mapped to LVR1 of the respective second memory. R7 of the memory 718 is mapped to LVR0 of the eighth NUMA partition 704 and R71 of the memory 720 is mapped to LVR1 of the eighth NUMA partition 704.

The message passing logic distributes the data according to the virtual ranks and virtual leader ranks and virtual subordinate ranks of implementation 900 at least in the way data is distributed as described with reference to implementation 700.

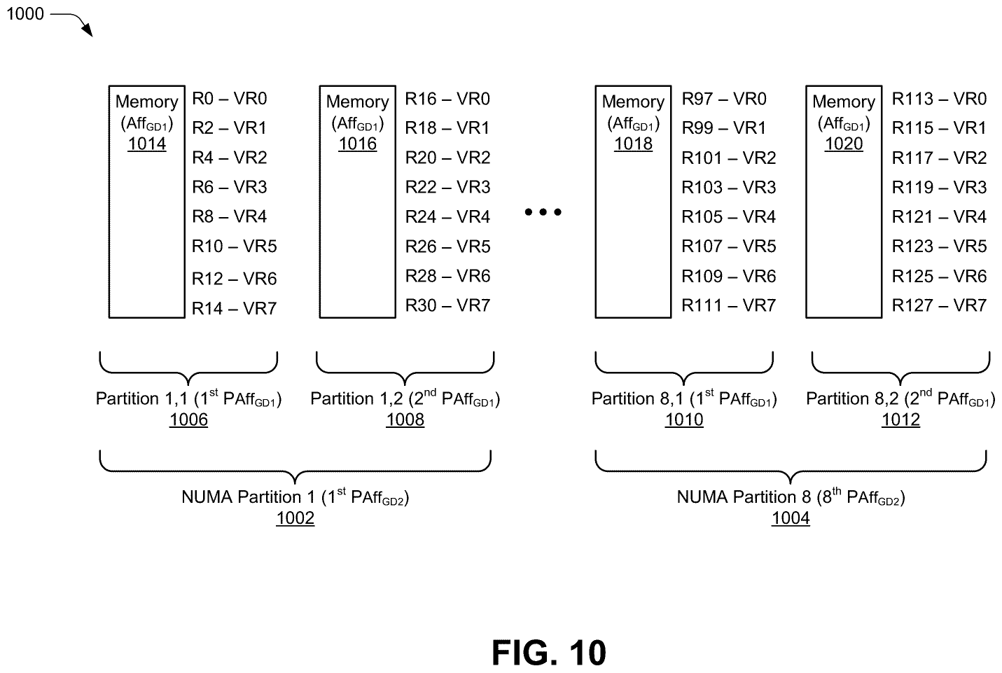

FIG. 10 is a block diagram of a non-limiting example implementation of mapping and topology awareness in an example of implementing the MPI processing system of FIGS. 1 and/or 2.

In the illustrated example, implementation 1000 depicts two NUMA partitions of eight total NUMA partitions within a given socket partition (e.g., NUMA 110 to NUMA 112 within socket 106 of FIG. 1). In particular, implementation 1000 depicts the first NUMA partition 1002 (PAff_{GD2}) and the eighth NUMA partition 1004 (PAff_{GD2}). The first NUMA partition 1002 includes a first memory partition 1006 (PAff_{GD1}) and a second memory partition 1008 (PAff_{GD1}). The eighth NUMA partition 1004 includes a first memory partition 1010 (PAff_{GD1}) and a second memory partition 1012 (PAff_{GD1}). As shown, the first memory partition 1006 includes a memory 1014 (AFF_{GD1}) and the second memory partition 1008 includes a memory 1016 (AFF_{GD1}). Also, the first memory partition 1010 includes a memory 1018 (AFF_{GD1}) and the second memory partition 1012 includes a memory 1020 (AFF_{GD1}).

Implementation 1000 depicts a ranks-to-virtual ranks mapping and leader ranks for a processor architecture with 128 processes and two active affinity domains of memory and eight NUMA affinity domains, where, Lᵢⱼ=8 (e.g., eight NUMA partitions per socket), and M₁=2 (e.g., two memory partitions per NUMA).

Implementation 1000 depicts a rank assignment where the processes of the memory 1014 are assigned the ranks R0, R2, R4, R6, R8, R10, R12, and R14. The processes of the memory 1016 are assigned the ranks R16, R18, R20, R22, R24, R26, R28, and R30. The processes of the memory 1018 are assigned the ranks R97, R99, R101, R103, R105, R107, R109, and R111. The processes of the memory 1020 are assigned the ranks R113, R115, R117, R119, R121, R123, R125, and R127.

In the illustrated example, the ranks of the memories 1014, 1016, 1018, and 1020 are respectively mapped to VR0 to VR7. In the illustrated example, VR0 of the first memory partition 1006 is a virtual leader rank LVR0 of the first memory partition 1006 (e.g., root rank of the eight NUMA partitions). Simultaneously, VR0 of the first memory partition 1006 is a virtual leader rank LVR0 of the first NUMA partition 1002. The virtual leader rank LVR0 of the first NUMA partition 1002 is an overall virtual leader rank (LCAff_{GD2}) for the eight NUMA partitions (CAff_{GD2}). Accordingly, for a one-to-all MPI collective function, LVR0 of the first NUMA partition 1002 receives data from the virtual leader rank of the socket level that encapsulates the eight NUMA partition 1002 to 1004 (e.g., LVR0 is equivalent to the virtual leader rank of the socket level encapsulating the eight NUMA partitions 1002 to 1004). LVR0 of the first NUMA partition 1002 distributes the data to the virtual leaders ranks of each of the other NUMA partitions.

In one or more examples, LVR0 mapped to R0 is the virtual leader rank of the first NUMA partition 1002, LVR1 mapped to R32 of a second NUMA partition (not shown) is the virtual leader rank of the second NUMA partition, LVR2 mapped to R64 of a third NUMA partition (not shown) is the virtual leader rank of the third NUMA partition, LVR3 mapped to R96 of a fourth NUMA partition (not shown) is the virtual leader rank of the fourth NUMA partition, LVR4 mapped to R1 of a fifth NUMA partition (not shown) is the virtual leader rank of the fifth NUMA partition, LVR5 mapped to R33 of a sixth NUMA partition (not shown) is the virtual leader rank of the sixth NUMA partition, LVR6 mapped to R65 of a seventh NUMA partition (not shown) is the virtual leader rank of a seventh NUMA partition, and LVR7 mapped to R97 is the virtual leader rank of the eighth NUMA partition 1004. Accordingly, LVR0 of the first NUMA partition 1002 receives the data for all eight NUMA partitions, and then LVR0 of the first NUMA partition 1002 distributes the data to the group of virtual leader ranks of the other seven NUMA partitions, including the eighth NUMA partition 1004 (e.g., regardless of the rank assignment, topology, etc.).

In one or more examples, one rank from each of the eight NUMA partitions is selected as a local memory virtual leader rank of each set of memory partitions. For example, R0 of the memory 1014 is mapped to LVR0 of the first NUMA partition 1002 and R16 of the memory 1016 is mapped to LVR1 of the second memory partition 1008. Similarly, R32 of a first memory of the second NUMA partition is mapped to LVR0 of the respective first memory and R48 of a second memory of the second NUMA partition is mapped to LVR1 of the respective second memory. R64 of a first memory of the third NUMA partition is mapped to LVR0 of the respective first memory and R80 of a second memory of the third NUMA partition is mapped to LVR1 of the respective second memory. R96 of a first memory of the fourth NUMA partition is mapped to LVR0 of the respective first memory and R112 of a second memory of the fourth NUMA partition is mapped to LVR1 of the respective second memory. R1 of a first memory of the fifth NUMA partition is mapped to LVR0 of the respective first memory and R17 of a second memory of the fifth NUMA partition is mapped to LVR1 of the respective second memory. R33 of a first memory of the sixth NUMA partition is mapped to LVR0 of the sixth NUMA partition and R49 of a second memory of the sixth NUMA partition is mapped to LVR1 of the respective second memory. R65 of a first memory of the seventh NUMA partition is mapped to LVR0 of the respective first memory and R81 of a second memory of the seventh NUMA partition is mapped to LVR1 of the respective second memory. R97 of the memory 718 is mapped to LVR0 of the eighth NUMA partition 704 and R113 of the memory 720 is mapped to LVR1 of the eighth NUMA partition 704.

The message passing logic distributes the data according to the virtual ranks and virtual leader ranks and virtual subordinate ranks of implementation 1000 at least in the way data is distributed as described with reference to implementation 700.

Thus, regardless of the process-to-resource mapping, the message passing logic groups the ranks belonging to a resource group at each hierarchy level (e.g., affinity group). Accordingly, the message passing logic achieves improved performance on any MPI collective for any processor architecture.

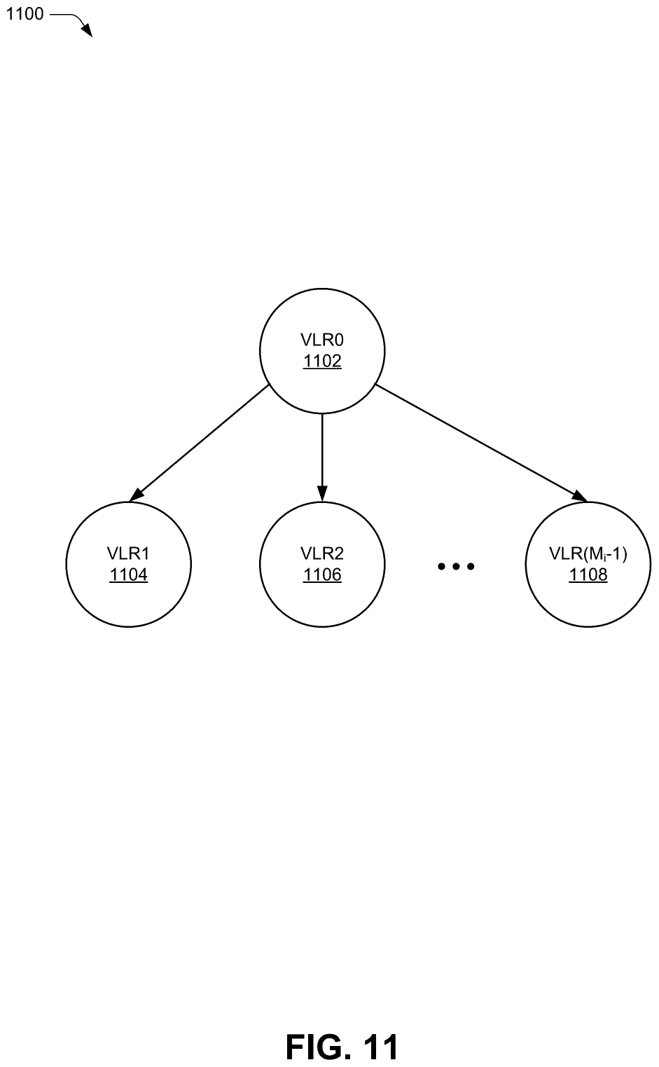

FIG. 11 is a block diagram of a non-limiting example implementation of topology selection in an example of implementing the MPI processing system of FIGS. 1 and/or 2.

Implementation 1100 depicts one of multiple topologies that can be applied to an affinity domain level. In one or more examples, the message passing logic includes selecting the tree topology and applying a selected tree topology to an affinity domain level.

In the illustrated example, a broadcast MPI function distributes data among virtual leader ranks at affinity domain level i using a flat tree topology. As shown, a first virtual leader rank VLR0 1102 (e.g., a root rank) distributes data to subordinate virtual leader ranks that include a second virtual leader rank VLR1 1104, a third virtual leader rank VLR2 1106, up to an Mth virtual leader rank VLRMᵢ₋₁ 1108.

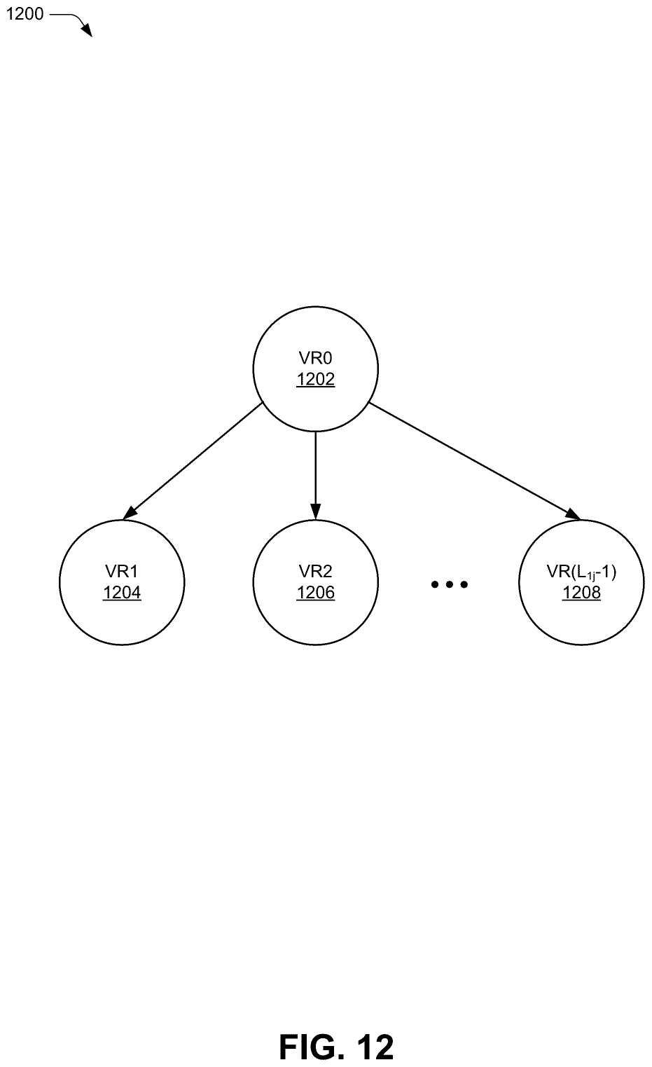

FIG. 12 is a block diagram of a non-limiting example implementation of topology selection in an example of implementing the MPI processing system of FIGS. 1 and/or 2.

Implementation 1200 depicts one of multiple topologies that can be applied to an affinity domain level. In one or more examples, the message passing logic includes selecting the tree topology and applying a selected tree topology to an affinity domain level.

In the illustrated example, a broadcast MPI function within the ranks of partition j at affinity domain level 1 use a flat tree topology. As shown, a first virtual rank VR0 1202 distributes data to subordinate virtual ranks that include a second virtual rank VR1 1204, a third virtual rank VR2 1206, up to an Lth virtual rank VR (Lᵢⱼ₋₁) 1208 at affinity domain level 1.

Based on the message passing logic, the number of cross-memory data transfers are significantly reduced, thereby improving latency for MPI collective functions.

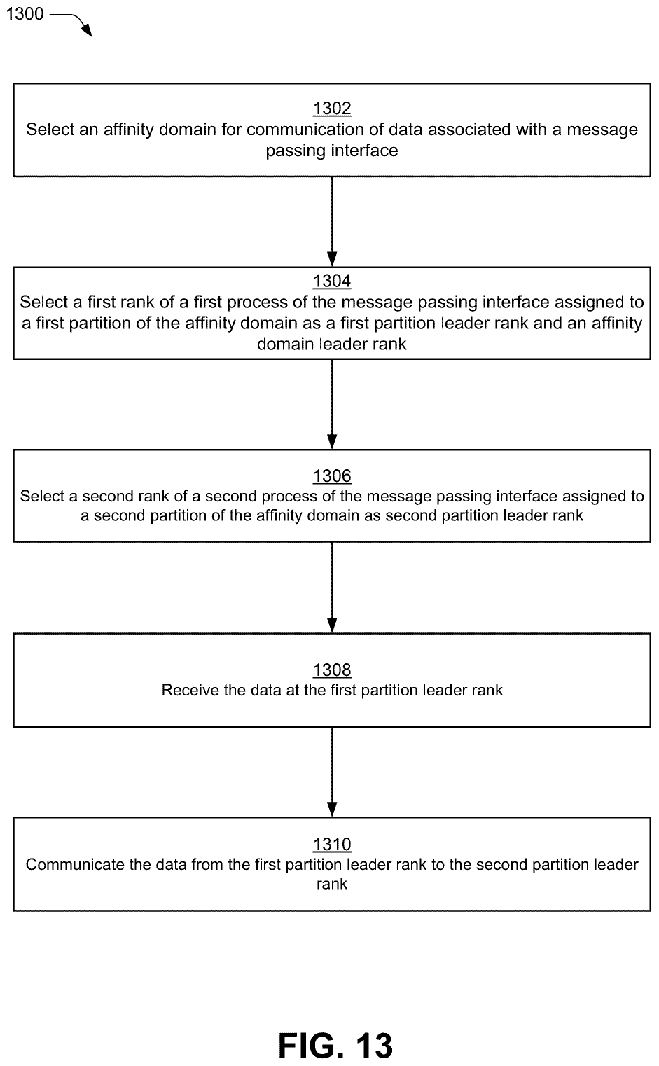

FIG. 13 is a flow diagram depicting an algorithm as a step-by-step procedure 1300 in an example of implementing an MPI processing system configured to perform mapping-aware and memory topology-aware MPI collectives.

An affinity domain for communication of data associated with a message passing interface is selected (block 1302). For example, MPI processing system may select one or more affinity domains based on based on message size, tree topology, process affinity, processor architecture, etc.

A first rank of a first process of the message passing interface is selected (block 1304). The first rank is assigned to a first partition of the affinity domain as a first partition leader rank and as an affinity domain leader rank.

A second rank of a second process of the message passing interface is selected (block 1306). The second rank is assigned to a second partition of the affinity domain as second partition leader rank. In accordance with the techniques described herein, the first partition leader rank and the second partition leader rank are grouped in a group of leader ranks.

The data is received at the first partition leader rank (block 1308). In accordance with the techniques described herein, the first partition leader rank receives the data from another level (e.g., from a higher level from one-to-all operations, from a lower level from all-to-one operations).

The data is communicated from the first partition leader rank to the second partition leader rank (block 1310). In accordance with the techniques described herein, the first partition leader rank distributes the data to other partitions within the same level (e.g., among NUMA partitions within the same socket).

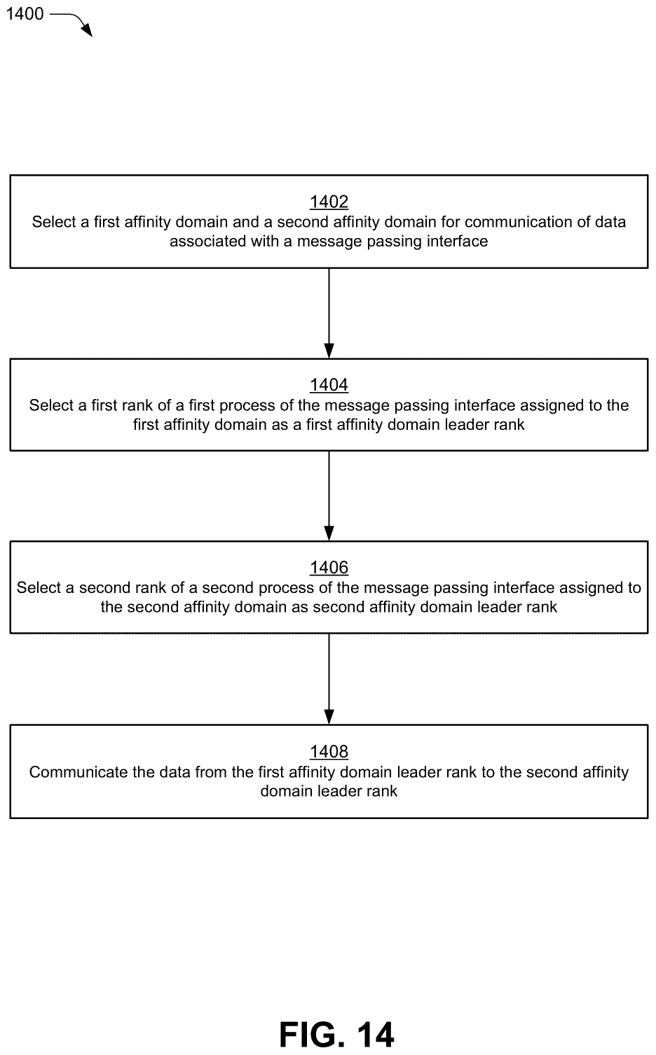

FIG. 14 is a flow diagram depicting an algorithm as a step-by-step procedure 1400 in an example of implementing an MPI processing system configured to perform mapping-aware and memory topology-aware MPI collectives.

A first affinity domain and a second affinity domain are selected for communication of data associated with a message passing interface (block 1402). In accordance with the techniques described herein, for a given MPI operation, the NUMA level and the socket level are selected for communication of MPI data.

A first rank of a first process of the message passing interface assigned to the first affinity domain is selected as a first affinity domain leader rank (block 1404). In accordance with the techniques described herein, a root rank of a socket partition is selected as a first affinity domain leader rank (e.g., leader rank over all socket partitions within a given node).

A second rank of a second process of the message passing interface assigned to the second affinity domain is selected as second affinity domain leader rank (block 1406). In accordance with the techniques described herein, a root rank of a NUMA partition is selected as a first affinity domain leader rank (e.g., leader rank over all NUMA partitions within a given socket).

The data is communicated from the first affinity domain leader rank to the second affinity domain leader rank (block 1408). In accordance with the techniques described herein, the data is communicated from a first leader rank to a second leader rank across affinity domains. Each affinity domain then distributes the data, thus minimizing cross-affinity-domain data transfers for the MPI communication.

The various functional units illustrated in the figures and/or described herein (including, where appropriate, the node 102, the sockets 106 and 108, the NUMA 110 to the NUMA 116, etc.) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), one or more Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A node comprising:
one or more processors; and
one or more computer-readable storage media storing instructions that are executable by the one or more processors to cause the node to:
select an affinity domain for communication of data associated with a message passing interface;
select a first rank of a first process of the message passing interface assigned to a first partition of the affinity domain as a first partition leader rank and an affinity domain leader rank;
select a second rank of a second process of the message passing interface assigned to a second partition of the affinity domain as second partition leader rank;
receive the data at the first partition leader rank; and
communicate the data from the first partition leader rank to the second partition leader rank.

2. The node of claim 1, wherein reception of the data at the first partition leader rank is based on:
the selection of the first partition leader rank as the affinity domain leader rank; and
the affinity domain leader rank being mapped, by the node, to a virtual affinity domain leader rank.

3. The node of claim 1, wherein the communication of the data from the first partition leader rank to the second partition leader rank is based on at least one of:
the selection of the first partition leader rank as the affinity domain leader rank; and
the second partition leader rank being subordinate to the affinity domain leader rank within the affinity domain.

4. The node of claim 1, wherein the communication of the data from the first partition leader rank to the second partition leader rank is based on:
the first partition leader rank being mapped, by the node, to a virtual first partition leader rank; and
the second partition leader rank being mapped, by the node, to a virtual second partition leader rank subordinate to the virtual first partition leader rank.

5. The node of claim 4, wherein further instructions are executable by the one or more processors to cause the node to communicate the data from the first partition leader rank to each of one or more first partition subordinate ranks, the first partition including the first partition leader rank and the one or more first partition subordinate ranks.

6. The node of claim 5, wherein the communication of the data from the first partition leader rank to each of the one or more first partition subordinate ranks is based on a mapping of:
the first partition leader rank to the virtual first partition leader rank; and
each of the one or more first partition subordinate ranks to respective virtual first partition subordinate ranks.

7. The node of claim 4, wherein further instructions are executable by the one or more processors to cause the node to:
map each of one or more second partition subordinate ranks to respective virtual second partition subordinate ranks; and
communicate the data from the virtual second partition leader rank to the respective virtual second partition subordinate ranks.

8. The node of claim 1, wherein the selection of the affinity domain is based on further instructions executable by the one or more processors to cause the node to select one or more affinity domains for the communication of the data from a list of affinity domains that includes a node level, a socket level within the node level, a non-uniform memory access level within the socket level, a memory level within the non-uniform memory access level, and a processor core level within the memory level.

9. The node of claim 8, wherein the selection of the affinity domain is based on at least one of a processor architecture, a mapping of processes of the message passing interface to hardware resources of the node, or a size of the data.

10. The node of claim 9, wherein the selection of the affinity domain is based on further instructions executable by the one or more processors to cause the node to:
select at least the processor core level when a message size is below a first threshold;
select at least the processor core level and the memory level when the message size exceeds the first threshold;
select at least a majority of affinity domains from the list of affinity domains when the message size exceeds a second threshold greater than the first threshold;
select at least the node level and the socket level when the message size exceeds a third threshold greater than the second threshold; and
select at least the node level when the message size exceeds a fourth threshold greater than the third threshold.

11. A method comprising:
selecting an affinity domain for communication of data associated with a message passing interface;
selecting a first rank of the message passing interface assigned to a first partition of the affinity domain as a first partition leader rank and an affinity domain leader rank;
selecting a second rank of the message passing interface assigned to a second partition of the affinity domain as second partition leader rank;
receiving the data at the first partition leader rank; and
communicating the data from the first partition leader rank to the second partition leader rank.

12. The method of claim 11, wherein receiving the data at the first partition leader rank is based on:
the selecting the first partition leader rank as the affinity domain leader rank, wherein the affinity domain leader rank is a leader rank for an immediate next higher level affinity domain partition; and
mapping the affinity domain leader rank to a virtual affinity domain leader rank.

13. The method of claim 11, wherein the communicating the data from the first partition leader rank to the second partition leader rank is based on at least one of:
the selecting the first partition leader rank as the affinity domain leader rank; and
the second partition leader rank being subordinate to the affinity domain leader rank within the affinity domain.

14. The method of claim 11, wherein the communicating the data from the first partition leader rank to the second partition leader rank is based on:
mapping the first partition leader rank to a virtual first partition leader rank; and
mapping the second partition leader rank to a virtual second partition leader rank subordinate to the virtual first partition leader rank.

15. The method of claim 14, further comprising communicating the data from the first partition leader rank to each of one or more first partition subordinate ranks, the first partition including the first partition leader rank and the one or more first partition subordinate ranks.

16. The method of claim 15, wherein the communication of the data from the first partition leader rank to each of the one or more first partition subordinate ranks is based on:
mapping the first partition leader rank to a virtual first partition leader rank; and
mapping each of the one or more first partition subordinate ranks to respective virtual first partition subordinate ranks.

17. A node comprising:
one or more processors; and
one or more computer-readable storage media storing instructions that are executable by the one or more processors to cause the node to:
select a first affinity domain partition of an affinity domain and a second affinity domain partition of the affinity domain for communication of data associated with a message passing interface;
select a first rank of the message passing interface assigned to the first affinity domain partition as a first affinity domain leader rank;
select a second rank of the message passing interface assigned to the second affinity domain partition as second affinity domain leader rank; and
communicate the data from the first affinity domain leader rank to the second affinity domain leader rank.

18. The node of claim 17, wherein further instructions are executable by the one or more processors to cause the node to:
assign a first tree topology to the first affinity domain partition; and
assign, to the second affinity domain partition, a second tree topology.

19. The node of claim 17, wherein the communication of the data from the first affinity domain leader rank to the second affinity domain leader rank is based on further instructions executable by the one or more processors to cause the node to map:
the first affinity domain leader rank to a first virtual affinity leader rank; and
the second affinity domain leader rank to a second virtual affinity leader rank.

20. The node of claim 17, wherein the communication of the data from the first affinity domain leader rank to the second affinity domain leader rank is based on further instructions executable by the one or more processors to cause the node to:
group the first affinity domain leader rank and the second affinity domain leader rank with a group of leader ranks of the affinity domain;
map the first affinity domain leader rank as a virtual first affinity domain leader rank over the group of leader ranks; and
map the second affinity domain leader rank as a second virtual affinity group leader rank of the group of leader ranks.
